(19) United States
(12) Patent Application Publication
(10) Pub. No.: US 2026/0025475 A1
(43) Pub. Date: Jan. 22, 2026

(54) IMAGE SIGNAL PROCESSING FOR RGB-IR SENSOR ARRAYS

(71) Applicant: NVIDIA Corporation, Santa Clara, CA (US)

(72) Inventors: Sean Midthun PIEPER, Waldport, OR (US); Robin Brian Jenkin, Morgan Hill, CA (US); Gopal Triplicane Venkatesan, Sunnyvale, CA (US)

(21) Appl. No.: 18/775,873

(22) Filed: Jul. 17, 2024

(51) Int. Cl. H04N 1/60; G06T 5/70; G06T 5/73; G06T 5/92; G06T 7/90; G06V 10/143; G06V 10/60

(52) U.S. Cl. CPC H04N 1/60; G06T 5/70; G06T 5/73; G06T 5/92; G06T 7/90; G06V 10/143; G06V 10/60; G06T 2207/10024

(57) ABSTRACT

In various examples, image signal processing (ISP) using infrared (IR) image-based control for visible wavelength color data channel processing is presented. Image color data channel processing stages of an ISP pipeline are configured to exploit IR information represented in an IR-based control channel so that IR information may be used to enhance the image processing for human visualization and machine perception functions. In some embodiments, a pseudo-radiometric (PR) channel may be formed based on the color data and IR data channels and propagated through the ISP pipeline. An IR-based control channel may carry control data computed based on luma data, IR channel data, PR channel data, image statistics, or combinations thereof. Image modulators may be derived from the control channel, and the image modulator used by one or more of the image color data channel processing stages of the ISP pipeline to adjust the visible wavelength color data channels.

### BACKGROUND

Advanced Driver Assistance Systems (ADASs) represent an evolving technology in the automotive industry to provide features such as occupant monitoring systems (OMSs). OMSs perform real-time assessments of driver and occupant presence, gaze, alertness, or other conditions for reliable detection and recognition of safety-critical information. Increasingly, the optical image sensors used to capture image data for these OMS assessments are devices that capture image frames that include visual spectrum color data (e.g., RGB data) as well as non-visible infrared (IR) data. For example, OMS optical image sensors may comprise a monocular optical image sensor, such as a camera, that captures RGB-IR image frames of a vehicle interior using a CMOS sensor.

### SUMMARY

Embodiments of the present disclosure relate to image signal processing using infrared image-based control for visible wavelength color data channel processing.

In contrast to conventional systems, one or more of the embodiments herein, among other things, present an image signal processor (ISP) pipeline that includes a control channel that propagates IR image data through one or more image color data channel processing stages of the ISP, along with visible wavelength color data channels that carry visible color data. Although IR light does accurately convey details about structures, objects, and/or backgrounds of a scene, it does so based on a spectrum of light that is not visible to the eye of human beings. Computer graphics renderings of a scene based on IR light therefore may not visually appear the same as the scene would appear to a human being with the naked eye. As such, with respect to color image processing of color data (such as RGB color data), the presence of IR data in the color channels has been considered a source of contamination and/or noise. The image color data channel processing stages of the ISP pipeline are configured to exploit the IR information represented in the control channel during image processing so that IR information may be used to enhance the image data for human visualization and machine perception functions. In some embodiments, a pseudo-radiometric (PR) channel may be formed as the weighted sum of the color data and IR data channels and propagated through the ISP pipeline. An IR-based control channel may carry control data computed based on luma data, IR channel data, PR channel data, image statistics, or combinations thereof. Image modulators may be derived from the control channel, and the image modulator may be used by one or more of the image color data channel processing stages of the ISP pipeline to adjust the visible wavelength color data channels.

### BRIEF DESCRIPTION OF THE DRAWINGS

The present systems and methods for infrared image-based control for visible wavelength color data channel processing are described in detail below with reference to the attached drawing figures, wherein:

FIG. 1 is a data flow diagram for an image signal processing (ISP) system with IR-based control channel, in accordance with some embodiments of the present disclosure;

FIG. 2 is a data flow diagram for an ISP pipeline that uses infrared image-based control, in accordance with some embodiments of the present disclosure;

FIG. 3 is a flow diagram for a method for image signal processing using infrared image-based control, in accordance with some embodiments of the present disclosure;

FIG. 4 is a diagram illustrating highlight recovery correction using IR data, in accordance with some embodiments of the present disclosure;

FIG. 5A is an illustration of an example autonomous vehicle, in accordance with some embodiments of the present disclosure;

FIG. 5B is an example of camera locations and fields of view for the example autonomous vehicle of FIG. 5A, in accordance with some embodiments of the present disclosure;

FIG. 5C is a block diagram of an example system architecture for the example autonomous vehicle of FIG. 5A, in accordance with some embodiments of the present disclosure;

FIG. 5D is a system diagram for communication between cloud-based server(s) and the example autonomous vehicle of FIG. 5A, in accordance with some embodiments of the present disclosure;

FIG. 6 is a block diagram of an example computing device suitable for use in implementing some embodiments of the present disclosure; and

FIG. 7 is a block diagram of an example data center suitable for use in implementing some embodiments of the present disclosure.

### DETAILED DESCRIPTION

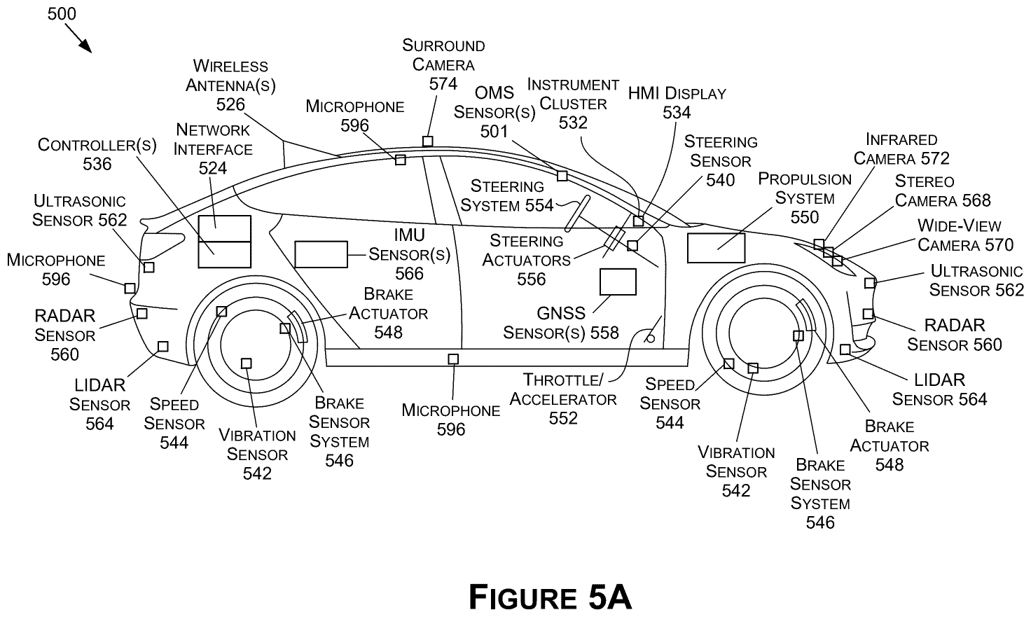

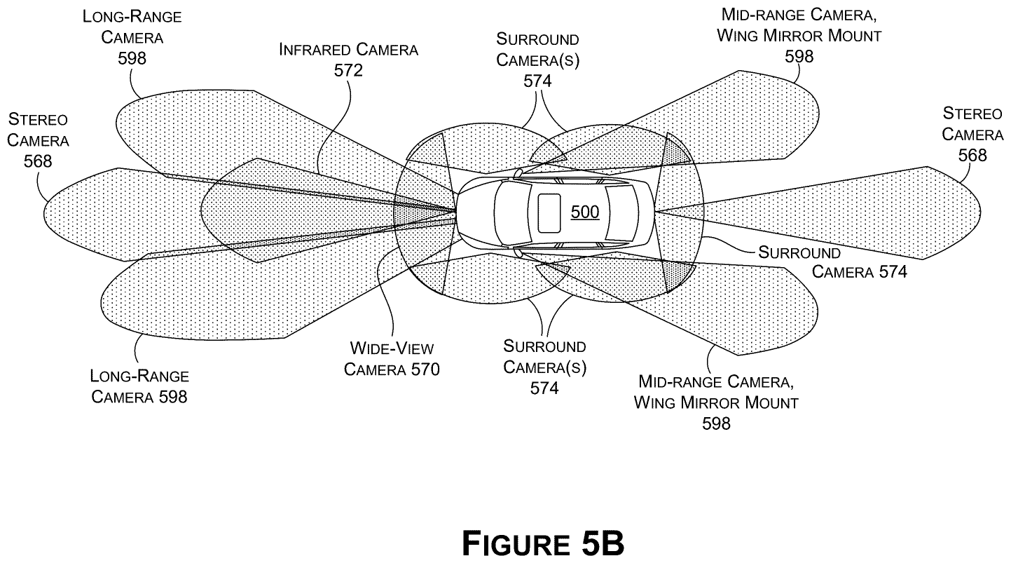

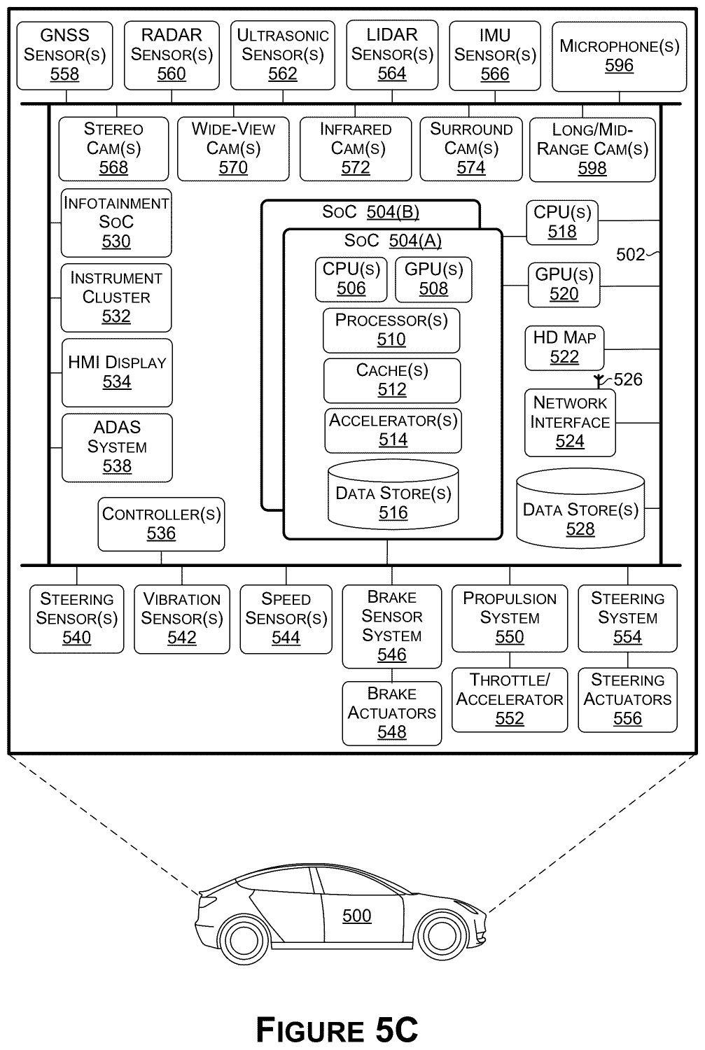

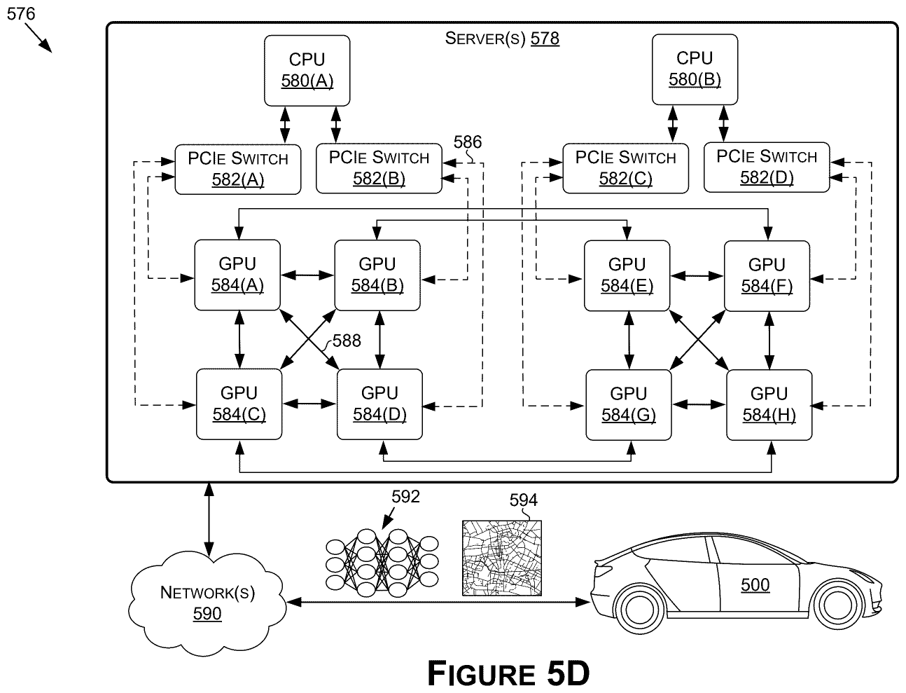

Systems and methods are disclosed related to infrared image-based control for visible wavelength color data channel processing. Although the present disclosure may be described with respect to an example autonomous or semi-autonomous vehicle or machine 500 (alternatively referred to herein as “vehicle 500” or “ego-machine 500,” an example of which is described with respect to FIGS. 5A-5D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to image signal processing for ego-machines or vehicles, this is not intended to be limiting, and the systems and methods described herein may be used in augmented reality, virtual reality, mixed reality, robotics, security and surveillance, autonomous or semi-autonomous machine applications, and/or any other technology spaces where image signal processors may be used.

The optical image sensors used to capture image data for occupant monitoring systems (OMSs) are primarily devices that capture image frames that include visual spectrum color data (e.g., RGB data) as well as non-visible infrared (IR) data. Because the CMOS sensors used in these optical image sensors have a strong response to IR and near-IR wavelength light, many color and non-color cameras include an IR-cut filter (e.g., a coating or element in the camera lens stack). However for RGB-IR sensors, IR light may be intentionally passed to the sensor via a notch filter so that the same amount of IR light is received at the RGB and IR pixels. As such, even with the use of an IR-cut filter, a substantial amount of IR wavelength light can still reach the CMOS sensor and affect the values of the color data channels. IR data may refer to data representing such non-visible IR wavelengths of electromagnetic radiation (IR light) in captured image data, and may include, for example, wavelengths categorized as near-infrared, infrared, and/or far-infrared.

Although IR light does accurately convey details about structures, objects and/or backgrounds of a scene, it does so based on a spectrum of light that is not visible to the eye of human beings. Computer-generated graphical renderings of a scene based on IR light therefore may not visually appear the same as the scene would appear to a human being with the naked eye. As such, with respect to color image processing of color data (such as RGB color data), the presence of IR data in the color channels has been considered a source of contamination and/or noise. Color data channels that at least approximate pure color channels have generally been computed by correcting pixel values for the local IR data component captured with the color data components by the sensors. That is, when an image signal processor (ISP) receives the raw image data from a camera, for each of the color channels associated with a pixel (e.g., the individual R, G, and B color channels), an IR value based on an IR channel measurement is subtracted. The remaining values in each of the individual color channels substantially comprises the respective color data with the IR value removed. The resulting color channels may then be individually processed by the ISP without further consideration of IR data from the IR channel.

However, limiting access of an ISP to just the IR-corrected color channels for image processing is problematic. For example, an ISP often will generate a luminance channel (luma channel, Y) from IR-corrected RGB color channels, using weighted averages of the R, G, and B components. However, the data available from the IR-corrected RGB color channels may only represent a small fraction of the available light signal actually reaching the sensor, adversely affecting the signal-to-noise ratio (SNR) of the luma channel-which may in turn degrade the accuracy of visualizations rendered from the RGB color channels. Further, the remaining color data values in the color channels will be limited to a range less than the full range of data values otherwise available from the sensor, adversely increasing the ratio of noise present in these color channels and adversely affecting the signal-to-noise ratio (SNR) of each color channel from which IR values were subtracted. It should be noted that while examples presented herein primarily discuss color channels having an RGB color space, this is not intended to be limiting and other embodiments may include color channels defined using any suitable color space (e.g., RGB, YUV, YCbCr, IPT, CIELAB, Red, Clear Blue (RCB), Red, Yellow, Cyan (RYCy), Red Clear, Green (RCG) or other color spaces and/or for other color filter array types).

Despite being in an IR band to which humans are generally not sensitive, IR images can reliably describe the structure of scenes very well. Scenes are often actively illuminated by IR light (either from ambient light sources or by active IR light sources), even in lighting conditions that appear not well-lit to human observers. Moreover, even though IR light is not visible to the human eye, the features in the IR data channel typically correlate very well spatially with objects in the scene that are visible to the human eye and appear in the color data. Omitting the availability of IR channel data from an ISP image-processing pipeline constrains opportunities to use otherwise available IR channel data to inform filtering and other image-processing enhancements to the color channels in ways that do not introduce IR image contamination. Furthermore, the IR channel may often benefit from a higher signal-to-noise ratio than visible light channel components due to the use of active illumination, such as IR light emitting diodes (LEDs) that can illuminate a scene (e.g., within a vehicle interior) in a spectrum not visible to a human and that will not adversely affect their adaption to night vision.

In contrast to traditional ISP pipelines, embodiments of this disclosure address the issues of processing image data that includes a substantial IR component. More specifically, one or more of the embodiments herein, among other things, present an ISP pipeline that includes a control channel that propagates IR image data through one or more image color data channel processing stages of the ISP, along with visible wavelength color data channels that carry the RGB visible color data.

The image color data channel processing stages of the ISP pipeline are configured to exploit the IR information represented in the control channel during image processing so that IR information may be used to enhance the image data for human visualization and machine perception functions. While the overall ratio of the IR image data signal level to visible wavelength color data signal level will change with respect to ambient illumination conditions and levels of active illumination, the image color data channel processing stages may use the generally high degree of spatial and signal correlation between IR and visible wavelength channels in the image data to adjust visible wavelength channels based on the IR image data. Signal correlation may be described as the ability to predict a missing channel pixel value in a channel of the RGB color channels based on the channel pixel values of the other channels that are available. The signals between the values of IR channel and visible wavelength channels may rise and fall with each other (e.g., based on a multiplicative scaling factor and/or offset). Spatial correlation thus provides a representation of the phenomena of individual channels changing at the same location in the image, but not necessarily to a consistently predictable value based on the other channels. Spatial correlation may be measured by calculating a first differential of the IR and color channels and locating areas in an image where both channels exhibit change in a gradient above a specified threshold amount. It should be noted that an overall spatial correlation between the visible color data and IR data within in image still exists even though signal correlation at individual points within the image may break down. Detection of a condition where spatial and signal correlation exist either singularly or at the same time may be used to further enhance the control of image processing and other mechanisms applied to the images by the color data channel processing stages of the ISP.

As an example, in some embodiments a control channel may be generated based on a control coefficient, C, where C may be computed from an absolute difference between the logarithms of the luma and IR channels. For example, in some embodiments C may be computed based on the expression:

$$C = abs ( a * log ( Y ) - b * log ( IR ) ) ,$$

where a and b are scaling coefficients, Y is a luma channel formed from the visible wavelength color data channels (e.g., RGB or other visible color space data channels), and IR is the value of the IR channel. The control coefficient, C, may then be used to produce an image-carrying control channel to smoothly adjust processing applied by one or more of the image color data channel processing stages to the visible wavelength color data channels for an image.

The higher signal-to-noise ratio (SNR) of the IR data in the IR channel can be used to improve overall image processing, especially in low-ambient light conditions and when used to form a control mechanism such as the above control channel to control image color data channel processing stages within the ISP pipeline (e.g., white balance, tone mapping, noise reduction, and/or other image adjustments). In some embodiments, a pseudo-radiometric (PR) channel may be formed as the weighted sum of the color data and IR data channels and propagated through the ISP pipeline. The weighting of the individual color data and IR data channels to compute the PR channel may be varied based on the use case for the image data being processed by the ISP pipeline. For example, in some embodiments the color data and IR data channels may be weighted based on the quantum efficiency (QE) associated with the sensor that captured the image data, in order to mimic a sunlight curve or the curve of other ambient lighting conditions.

In some embodiments, the pseudo-radiometric (PR) channel may be used in place of, or in addition to, the luma, Y, channel for computing the control coefficient, C, and/or for otherwise forming the control channel. That is, a control channel may carry control data computed based on luma data, IR channel data, PR channel data, or combinations thereof. As discussed below, image modulators may be derived from the control channel (e.g., which may be derived from an image carried by the control channel), and the image modulator used by one or more of the image color data channel processing stages of an ISP to adjust the visible wavelength color data channels.

In this way, the ISP pipeline may be configured to propagate a control channel that includes, or is otherwise derived from, an IR channel and/or PR channel to each of the image color data channel processing stages of the ISP pipeline.

As an example, in some embodiments an ISP pipeline may include a sequence of image color data channel processing stages that perform image processing on visible wavelength spectrum (e.g., R, G, and B) color data channels. The exact number and order of image color data channel processing stages may vary depending on the intended use case and processing resources available to execute the ISP pipeline. In some embodiments, the ISP pipeline may input RGB-IR image data corresponding to a sensor-captured image frame which may include image data of a data stream received from an RGB-IR sensor or previously stored image data read from a memory. The ISP pipeline may then separate out the image data into data channels that may include, for example, red (R), green (G), and blue (B) visible wavelength color data channels, and a non-visible wavelength light (e.g., infrared or IR) data channel. From the R, G, B, and IR data channels, the IPS pipeline may compute a luma (Y) channel, and/or a pseudo-radiometric (PR) channel, which in turn may be used for computing the control channel. In some embodiments, this initial processing of the input image data may be performed by a color filter array (CFA) mapping stage of the ISP pipeline.

In some embodiments, one or more of the image color data channel processing stages may compute estimates of spatial and/or signal correlation between combinations of the visible wavelength color data and control channels using an area (e.g., an area of N×N pixels) centered on each pixel of a captured image frame. The channel statistics, spatial and signal correlation estimates, and/or the value of the control channel (together referred to collectively herein as image modulators) may then be used to modulate the behavior of the image data carried by the visible wavelength color data channels. In processing the visible wavelength color data channels, the image color data channel processing stages may thus apply the image modulators derived from the IR and/or PR channels, correlating the spatial/structure details available from the IR light captured by the sensor with visible wavelength color data-thus providing additional details about the captured scene to better render images in the color space of the visible wavelength color data channels. In some embodiments, one or more adjustments may be applied at the processing stages to at least one of an IR channel or a pseudo-radiometric (PR) channel of the image data using one or more of the image modulators determined at least in part from the control channel.

Moreover, because IR channel data can be obtained using non-visible wavelength IR light sources in low-visibility light conditions, the use of data from IR and/or PR channels can be used to continue to execute visible wavelength color data processing by image color data channel processing stages to enhance the otherwise limited visible color data that is present in the image data from the scene. The global or local ratio of a visible wavelength color data channel to an IR channel may be used for an image modulator to modulate the global or local application of color-correcting matrix (CCM) correction, particularly, but not limited to, the modification of color saturation and white balance of an output image produced from the ISP pipeline. Such a ratio may further allow for a graceful transition between operation of devices with active IR illumination (e.g., IR-emitting light-emitting diodes (LEDs)) in low-light scenarios, as compared to daylight or other scenarios where ample visible light is available. Moreover, in some embodiments, the ISP pipeline may use the data from IR and/or PR channels to perform an illuminant detection, detecting the type of sources of light present in captured image data based on assessing the amount or spectral distribution of light within the non-visible wavelength IR light data.

Image modulators applied by the image color data channel processing stages (derived from an IR and/or PR channel-based control channel) may adjust image parameters such as, but not limited to, white balance correction, tone mapping, demosaicing, color noise reduction, color correction, image sharpening, image scaling, or other image adjustments. It should be understood that discussion of the visible wavelength color data channels with respect to the RGB color space is for example purposes and not limiting. For example, in other embodiments, the visible wavelength color data channels may be defined based on other color spaces, such as the YUV color space that includes a luma (Y) channel and two chroma component channels, U (where Y=blue (B)−luma (Y)) and V (wherein V=red (R)−luma (Y)), and may be used with the non-visual spectrum infrared (IR) data channel.

An IR data channel and/or PR channel may be expected to have increased SNR as compared to the visible wavelength color data channels so that feature edges, uniform regions, and other structural details of an image are well-represented. Moreover, for areas of pixels within an image where the visible wavelength color data channels and non-visible wavelength IR data channel are not saturated, a PR channel computed from the non-saturated channel may have an increased dynamic range as compared to the visible wavelength color data channels. As a result, for embodiments where the output from the ISP pipeline is used for purposes such as machine-based object detection (e.g., using an artificial intelligence (AI) and/or Deep Neural Network (DNN) based inference engine), a PR channel output may improve detection performance over detection based on visible wavelength color data channels.

In some embodiments, image statistics gathered from image data processing performed at one image color data channel processing stage of an ISP pipeline may be used to define image modulators for processing image data at one or more subsequent image color data channel processing stages. Such image statistics may include, for example, image statistics for the individual visible wavelength color data channels, an IR image data channel, a PR channel, and/or a control channel derived from one or more of these channels. For example, in some embodiments, image statistics-based on the combination of visible wavelength color data channels and at least one non-visible wavelength data channel—may be processed by algorithms outside of the ISP pipeline that can be called by an image color data channel processing stage. The algorithm may be used to generate one or more image modulators that are used to control image adjustments performed by the image color data channel processing stage. In some embodiments, image statistics for individual channels and/or combinations of channels may include, for example, a mean pixel value and/or standard deviation for a captured image frame or for a selected region thereof. In some embodiments, image statistics for an image frame (or for a selected region thereof) may comprise one or more histograms computed for visible wavelength color data channels and/or non-visible wavelength data channels (e.g., an IR image data channel, a PR channel, and/or a control channel). Image statistics may include a coarse down-sampled representation of an image frame (e.g., 16×16 pixels or 64×64 pixels) including corresponding down-sampled visible wavelength color data channels and/or non-visible wavelength data channels. A down-sampled representation of an image frame may be used to ease computational burdens and/or speed the time to generate the image modulators used to control image adjustments performed by the image color data channel processing stages. Color statistics are not limited to a particular color space but may be computed for any applicable color space (e.g., RGB, YCbCr, IPT, CIELAB, Red, Clear, Blue (RCB), Red, Yellow, Cyan (RYCy), Red Clear, Green (RCG) or other channel color spaces and/or for other color filter array types).

Demosaic processing refers to a process used to reconstruct a full-color image by replacing missing color samples from an image sensor output based on interpolation of values from nearby pixels. With respect to an image color data channel processing stage performing demosaic processing, an image modulator derived from IR and/or PR data may be used to avoid blurring of the image across feature edges. The high SNR image data from the IR and/or PR data channels may be used to determine how to interpolate color data from pixels within an image feature rather than from pixels that cross feature edges. The more clearly defined edges from the IR and/or PR data provide a better estimate of where the edges are, which may be cross-correlated to the position of edges within the visible wavelength color data for an image frame.

Different light sources produce light having different color distributions so that the color of an object in a scene will appear differently depending on the light source that is illuminating the object. White balance, also referred to as color temperature and measured in degrees Kelvin (K), is a parameter that may be adjusted in an image so that white objects appear white in the captured image. With respect to an image color data channel processing stage performing a white balance adjustment, when a visible wavelength color data channel is saturated, applying a white balance gain correction based on visible wavelength color data can result in rendering a false color image-which typically causes red and blue channel values to rise above the green channel, producing a purple cast within the corrected image. An image color data channel processing stage using an image modulator derived from IR and/or PR data as described herein may be used to clip a red, green, and/or blue channel for an individual pixel at a value corresponding to the channel value minus the local IR level. The resulting visible wavelength color data channels may produce a visualization that is more gray in color (e.g., a loss of saturation), but at least not a false color image—thus avoiding application of a global amplification that reduces dynamic range and can otherwise degrade image quality.

Highlight recovery refers to a process used to recover highlights lost due to saturation (e.g., clipping caused by overexposure) of a color channel in a captured image. In some embodiments, an image color data channel processing stage using an image modulator derived from IR and/or PR data as described herein may be used to perform highlight recovery in a first region of a captured image where a visible wavelength color data channel (which may carry a composite of color data and IR data) is saturated, but the IR and/or PR channel is not. Color data from a second region (e.g., an adjacent region to the saturated region) signal may then be used to correlate with the IR signal. The saturated visible wavelength color data channel may be corrected with respect to highlight recovery based on the IR and/or PR data channels for the second region. In some embodiments, highlight recovery may be a component of a dynamic range correction that also brightens details in shadowed regions of the image.

It should be appreciated that the embodiments described herein may be used in the context of occupant monitoring for vehicles such as automobiles, trucks, trains, aircraft, spacecraft, and/or boat, but may be extended to other machinery such as remote-operated and/or autonomous devices (e.g., robots and drones), and industrial and/or construction machinery, and/or any other image signal processing application such as security, surveillance, night-vision applications, biometric identification applications, and/or area monitoring, using image sensors that capture visible wavelength color data and non-visible wavelength data, such as IR light.

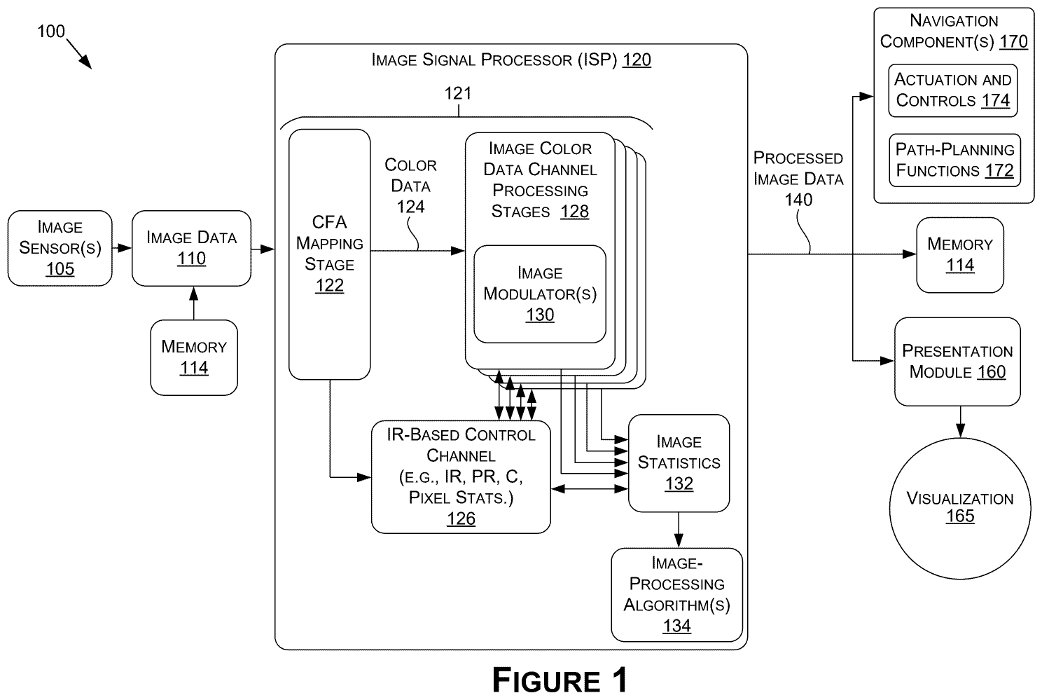

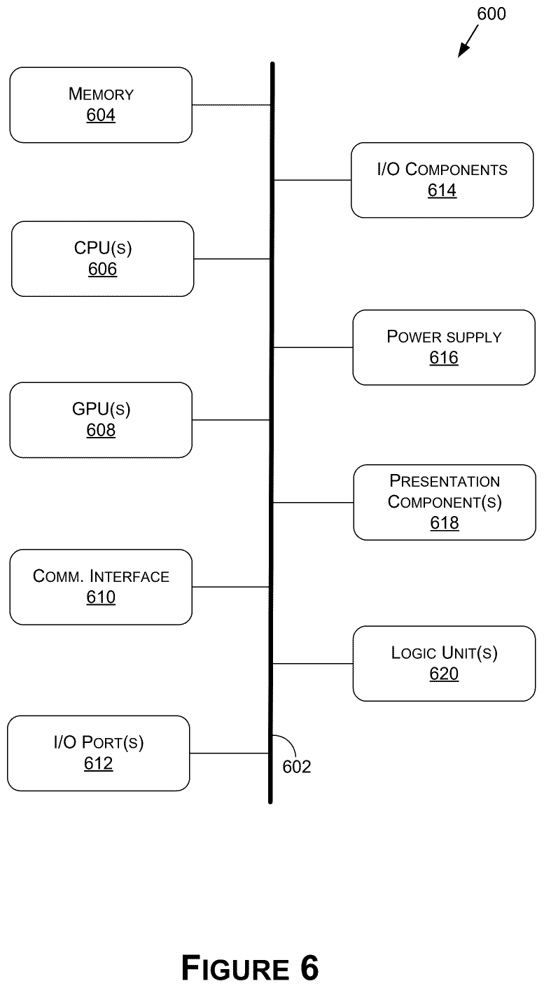

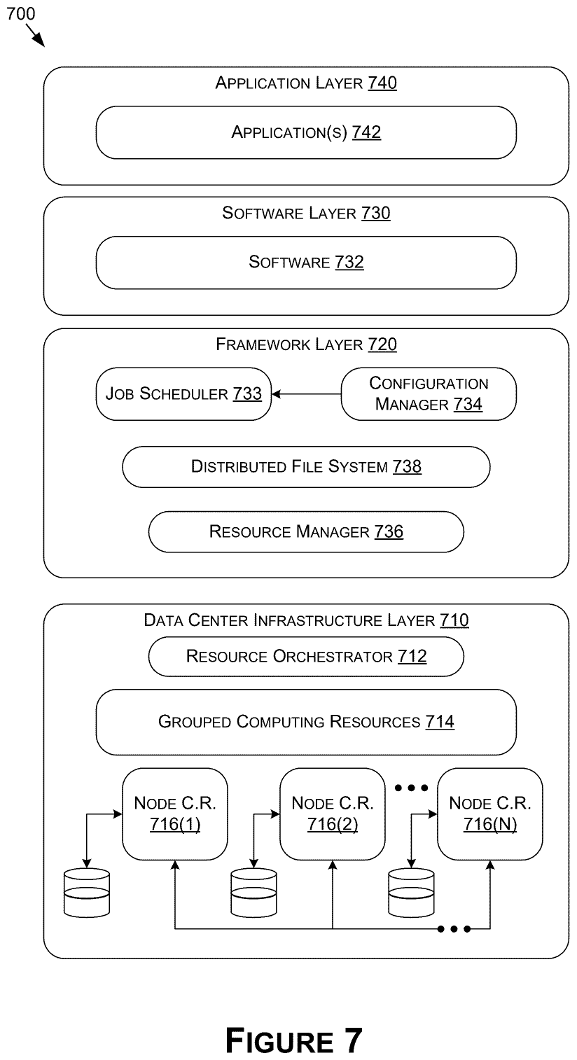

With reference to FIG. 1, FIG. 1 is an example data flow diagram for an IR control-based ISP system 100 for visible wavelength color data channel processing, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 500 of FIGS. 5A-5D, example computing device 600 of FIG. 6, and/or example data center 700 of FIG. 7.

As shown in FIG. 1, an IR control-based ISP system 100 may comprise an ISP 120 that includes an ISP pipeline 121 that inputs image data 110 and generates processed image data 140 based on applying one or more image-processing adjustments to the image data 110. In some embodiments, the ISP pipeline 121 may include a color filter array (CFA) mapping stage 122 that receives image data 110 and separates the image data into color data 124 and IR data for an IR-based control channel 126. The image data 110 may be produced by one or more image sensors 105 (e.g., a camera) that includes a CFA of small color filters placed over the pixel sensors of the image sensors 105. At the pixel level, the CFA filters light so that for each pixel sensor, a designated range of wavelengths—corresponding to a color channel—reaches the pixel sensor. For example, a red filter may pass red light to a pixel sensor to generate data for a red color channel, a blue filter may pass blue light to a pixel sensor to generate data for a blue color channel, and a green filter may pass green light to a pixel sensor to generate data for a green color channel. A Bayer filter is an example common 2×2 pixel RGB CFA that comprises one blue, one red, and two green filters. In some embodiments, for cameras that capture and generate data for non-visible IR wavelength light, the CFA may further include filter elements that pass the IR wavelength light to pixel sensors. For example, a standard Bayer filter may be adapted for an RGB-IR camera to substitute one of the two green filters with an NIR wavelength filter. In some embodiments, the CFA for an RGB-IR camera may comprise a 4×4 pixel RGB-IR CFA where 2 of 16 pixel filters are red, 2 of 16 pixel filters are blue, 8 of 16 pixel filters are green, and 4 of 16 pixel filters are IR. Although examples of CFA mapping may be described herein with respect to RGB color space, embodiments are not limited to RGB color filter arrays. For example CFA mapping (e.g. as performed by the CFA mapping stage 122) may, in some embodiments, be performed using other color spaces and color filter arrays such as, but not limited to, RCB (red, clear, blue) and IR, RCG (red, clear, green) and IR, RYCy (red, yellow, cyan) and IR or other color filter arrays.

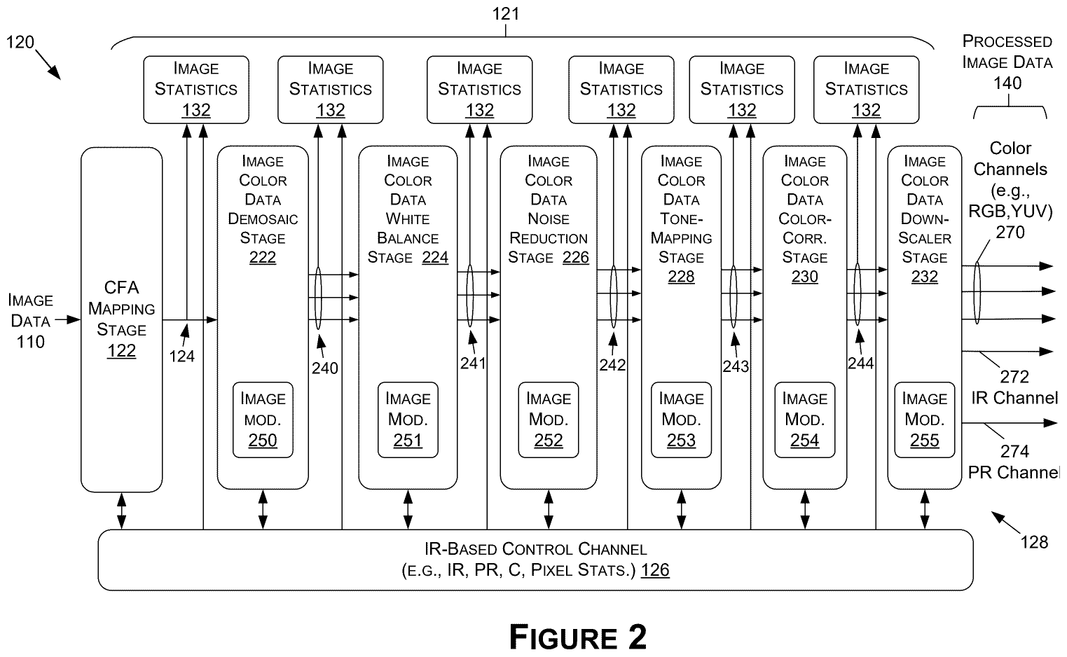

In some embodiments, color data 124 may comprise an up-sampled mapping of the visible wavelength color data (e.g., R, G, and B data) from image data 110. For example, in some embodiments, color data 124 may be generated as an up-sampled image of the visible wavelength color data from image data 110 based on a 2×2 CFA color space, such as, but not limited to, the RGGB pattern of a Bayer filter or other CFA pattern. The IR-based control channel 126 may comprise an up-sampled mapping of the non-visible wavelength data (e.g., IR data) from image data 110. As discussed herein, the IR-based control channel 126 may include IR image data, a channel based on data derived from IR image data (e.g., PR data-based image, image statistics, and/or a control channel coefficient, C). As discussed in greater detail with respect to FIG. 2, the ISP pipeline 121 may use the color data 124 as input to a series of image color data channel processing stages 128. Within the plurality of image color data channel processing stages 128, the color data 124 may be mapped into distinct logical color channels, each having a processing path through the image color data channel processing stages 128. As the color data in the color channels propagates through the image color data channel processing stages 128, each stage applies a filter, transformation, or other adjustment to the color channels, with the processed color channel output of a preceding stage providing the color channel input for the next stage in the image color data channel processing stage sequence of the ISP pipeline 121. The particular processing applied to the visible wavelength color data channels by an image color data channel processing stage 128 is controlled using image modulators 130 associated with the processing performed by that stage (e.g., demosaicing, white balance, noise reduction, and so forth as described herein), where the image modulators 130 may be derived at least in part from the IR-based control channel 126 that is propagated through the ISP pipeline 121 to the image color data channel processing stages 128. In some embodiments, the IR-based control channel 126 may include a pseudo-radiometric (PR) channel computed from a weighted sum of the color data and IR data channels and propagated through the ISP pipeline 121 as a component of the IR-based control channel 126. In some embodiments, the pseudo-radiometric (PR) channel may be used in place of, or in addition to, a luma, Y, channel for computing the control coefficient, C, and/or for otherwise forming the control channel. As previously discussed, the control coefficient, C, may be computed from an absolute difference between the logarithms of the luma and IR data and carried through the ISP pipeline 121 as a component of the IR-based control channel 126. The image modulators 130 may be derived from one or more of the components of the IR-based control channel 126 and may be used by one or more of the image color data channel processing stages 128 to adjust the visible wavelength color data channels.

In some embodiments, image statistics 132 may define a component of the IR-based control channel 126 that may be used to configure image modulators 130 for processing image data. Image statistics 132 based on the image-processing output of one image color data channel processing stage 128 may be used to define image modulators 130 for processing image data at one or more subsequent image color data channel processing stages 128. Image statistics 132 may be computed based on statistics for the individual visible wavelength color data channels, and/or components of the IR-based control channel 126 (e.g., non-visible wavelength IR image data or PR data). Image statistics 132 may be processed by one or more image-processing algorithms 134 outside of the ISP pipeline that can be called by an image color data channel processing stage 128. The image-processing algorithm(s) 134 may be used to generate one or more image modulators 130 that are used to control image adjustments performed by the image color data channel processing stage 128. In some embodiments, image statistics 132 for individual channels and/or combinations of channels may include, for example, a mean pixel value and/or standard deviation for a captured image frame or for a selected region thereof. In some embodiments, image statistics 132 based on a processed image output of an image color data channel processing stage 128 may include one or more histograms computed for visible wavelength color data channels and/or the IR-based control channel 126. Image statistics 132 may include a coarse down-sampled representation of an image frame (e.g., 16×16 pixels or 64×64 pixels) including corresponding down-sampled visible wavelength color data channels and/or non-visible wavelength data channels.

Image sensor(s) 105 may include, for example, RGB, IR, RGB-IR cameras, and/or other cameras, such as cameras described with respect to the vehicle 500 of FIGS. 5A-5D. The image sensor(s) 105 may include one or more cameras of an ego-object or ego-actor, such as stereo camera(s) 568, wide-view camera(s) 570 (e.g., fisheye cameras), infrared camera(s) 572, surround camera(s) 574 (e.g., 360° cameras), occupant monitoring system (OMS) sensor(s) 501, and/or long-range and/or mid-range camera(s) degree 598 of the autonomous vehicle 500 of FIGS. 5A-5D. The image sensor(s) 105 may be used to generate the image data 110 of the three-dimensional (3D) environment around the ego-object or ego-actor.

In some embodiments, ISP 120 may receive image data 110 as a live stream of image data from the image sensor(s) 105. In some embodiments, image data 110 may be previously captured image data provided to the ISP 120 from a memory 114. The processed image data 140 may be stored to a memory 114 from which it can be read and used as input by one or more other systems or processes such as, but not limited to, further image processing, generating training data, and/or rendering visualizations.

A presentation module 160 may cause presentation of a visualization 165 of at least a portion of the processed image data 140 (e.g., on a monitor visible to an occupant or operator of the ego-object or ego-actor). In some embodiments, the presentation module 160 projects the processed image data 140, or a portion thereof, onto a 3D representation of the 3D environment (e.g., a 3D bowl that models the 3D environment), renders a view of the processed image data 140 from the perspective of a virtual camera, and/or causes presentation of the rendered view as the visualization 165.

In some embodiments, the processed image data 140 may be used by one or more downstream navigation components 170 of an ego-machine, such as the controller(s) 536 discussed below. The downstream navigation components 170, for example, may implement functions such as object avoidance navigation functions and/or a world model manager, a path planner, a control component, a localization component, an obstacle avoidance component, an actuation component, and/or the like, to perform operations for controlling the ego-machine through an environment. In some embodiments, downstream navigation components 170 may include one or more deep neural networks (DNNs) that generate one or more predictions and/or inferences about the 3D environment based at least on the processed image data 140.

For some embodiments, the downstream navigation components 170 may include at least one or more path-planning functions 172 (such as path-planning functions for ego-machine 500) and/or actuation and controls 174 (such as the steering or break actuators or other controllers discussed herein with respect to ego-machine 500). For example, the path-planning functions 172 may include a configuration space manager, a freespace manager, a reachability manager, and a path evaluator. The configuration space manager may manage a pose configuration space, which represents poses comprising positions and orientations of the ego-machine in its environment. The freespace manager and the reachability manager may process the pose configuration space to determine one or more paths for maneuvering from a current pose to a target pose in the pose configuration space based at least in part on the processed image data 140. The path evaluator may identify one or more proposed or potential paths for the vehicle based at least on the assessment by the reachability manager.

With reference to FIG. 2, FIG. 2 illustrates an example data flow diagram for an ISP pipeline 121 for an ISP 120, such as is described with respect to the IR control-based ISP system 100 of FIG. 1, in accordance with some embodiments of the present disclosure. As shown in FIG. 2 and discussed with respect to FIG. 1, the image data 110 may be received by a CFA mapping stage 122, which generates color data 124 based on visible wavelength color data from the image data 110 and derives IR-based control channel 126 based at least on non-visible wavelength infrared (IR) data from the image data 110. In this example, the first of the image color data channel processing stages 128 comprises an image color data demosaic stage 222 which may perform a demosaic process to generate the logical color data channels 240 of visible wavelength color data. Image color data demosaic stage 222 may process the color data 124 into the logical color data channels 240 using an image modulator 250 derived based on IR data and/or PR data from the IR-based control channel 126. For example, the high SNR image data from the IR and/or PR data channels may be used to determine how to interpolate color data from pixels within an image feature rather than from pixels that cross feature edges.

The subsequent image color data channel processing stages 128 of pipeline 121 may each perform an image-processing adjustment to the color data channels 240 of visible wavelength color data as provided by a previous image color data channel processing stages 128 of pipeline 121. For example, in the ISP pipeline 121 shown in FIG. 2, image color data demosaic stage 222 outputs color data channels 240 to the image color data white balance stage 224 that may perform a white balance correction to the color data channels 240. White balance, also referred to as color temperature and measured in degrees Kelvin (K), is a parameter that may be adjusted in an image so that white objects appear white in the captured image. The white balance correction applied by the image color data white balance stage 224 may be based on the color data from color data channels 240 and an image modulator 251 derived from IR-based control channel 126. In some embodiments, the image modulator 251 for performing white balance correction may be determined at least in part on image statistics 132 computed from the color data channels 240.

The image color data white balance stage 224 outputs color data channels 241 to the image color data noise reduction stage 226 that may perform noise reduction corrections to the color data channels 241. Color noise is a process that may desaturate pixels that appear substantially different than adjacent colors or exhibit an uneven color transaction. The color noise correction applied by the image color data noise reduction stage 226 may be based on the color data from color data channels 241 and an image modulator 252 derived from IR-based control channel 126. In some embodiments, the image modulator 252 for performing noise reduction correction may be determined at least in part on image statistics 132 computed from the color data channels 241.

The image color data noise reduction stage 226 outputs color data channels 242 to the image color data tone-mapping stage 228 that may perform tone-mapping adjustments to the color data channels 242. Tone mapping may be used to scale tonal values for a set of color channels to map to a different dynamic range. The tone mapping applied by the image color data tone-mapping stage 228 may be based on the color data from color data channels 242 and an image modulator 253 derived from IR-based control channel 126. In some embodiments, the image modulator 253 for performing tone mapping may be determined at least in part on image statistics 132 computed from the color data channels 242.

The image color data tone-mapping stage 228 outputs color data channels 243 to the image color data color-correction stage 230 that may perform color-correction adjustments to the color data channels 243. Color corrections may address, for example, image tone and hue to make an image represented by color data channels 243 more natural. The color corrections applied by the image color data color-correction stage 230 may be based on the color data from color data channels 243 and an image modulator 254 derived from IR-based control channel 126. In some embodiments, the image modulator 254 for performing color correction may be determined at least in part on image statistics 132 computed from the color data channels 243.

The image color data color-correction stage 230 outputs color data channels 244 to the image color data down-scaler stage 232 that may perform a down-sampling to the color data channels 244. The down-sampling applied by the image color data down-scaler stage 232 may be based on the color data from color data channels 244 and an image modulator 255 derived from IR-based control channel 126. In some embodiments, the image modulator 255 for performing image down-sampling may be determined at least in part on image statistics 132 computed from the color data channels 244.

For each of these image color channel processing stages 128, the high SNR image data available from the IR and/or PR data of the IR-based control channel 126 may be used to determine how to interpolate color data from pixels within an image feature rather than from pixels that cross feature edges. The more clearly defined edges from the IR and/or PR data provide a better estimate of where the edges are, which may be cross-correlated to the position of edges within the visible wavelength color data for an image frame.

It should be understood that the particular type and order of image color channel processing stages 128 shown in ISP pipeline 121 is for illustrative purposes and not intended to be limiting. In other embodiments, ISP pipeline 121 may include a fewer or greater number of image color channel processing stages 128, stages applied in a different order, and/or stages that apply different image-processing operations on visible wavelength color data than those illustrated in FIG. 2.

The resulting output from the ISP pipeline 121 is the processed image data 140, which represents the accumulated adjustments to the image data 110 performed by the image color channel processing stages 128. In some embodiments, the processed image data 140 may include one or more color channels 270, which may be represented in an RGB, YUV, and/or other color space. The one or more color channels 270 may be used to present a rendering of the scene captured by image data 110, such as a rendering produced by visualization 165. In some embodiments, the processed image data 140 may include an IR image channel 272 and/or a PR image channel 274. The IR image channel 272 and/or a PR image channel 274 may be used as inputs to one or more downstream systems that may perform assessments and/or inferences based on the structural data representing objects and/or features present in the scene captured by image data 110 (e.g., navigation component 170).

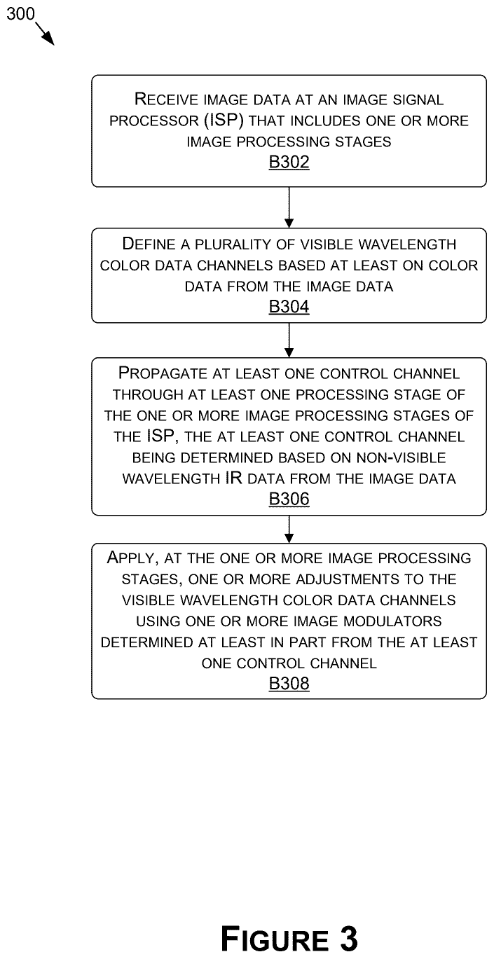

Now referring to FIG. 3, FIG. 3 is a flow diagram showing a method 300 for IR control-based image signal processing for visible wavelength color data channel processing, in accordance with some embodiments of the present disclosure. It should be understood that the features and elements described herein with respect to the method 300 of FIG. 3 may be used in conjunction with, in combination with, or substituted for elements of any of the other embodiments discussed herein and vice versa. Further, it should be understood that the functions, structures, and other descriptions of elements for embodiments described in FIG. 3 may apply to like or similarly named or described elements across any of the figures and/or embodiments described herein and vice versa.

Each block of method 300, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 300 is described, by way of example, with respect to the IR control-based ISP system 100 of FIG. 1. However, these methods may additionally or alternatively be executed by any one system, or any combination of systems, including, but not limited to, those described herein.

As discussed herein in greater detail, the method may include applying one or more image modulators to adjust visible wavelength color data channels of image data at one or more image color data channel processing stages of an image signal processor (ISP), the one or more image modulators based on at least one control channel propagated through the one or more image color data channel processing stages, the at least one control channel based at least on non-visible wavelength IR data from the image data.

Method 300, at block B302, includes image data at an image signal processor (ISP) that includes one or more image processing stages. The image data may be read from a memory, or received as an image stream from an optical image sensor. The image data may be produced by one or more image sensors (e.g., a camera) that includes a CFA of small color filters placed over the pixel sensors of the image sensors. The ISP pipeline may include a color filter array (CFA) mapping stage that receives image data and separates the image data into visible wavelength color data (e.g., in an RGB, YUV, or other color space) and IR data for an IR-based control channel.

Method 300, at block B304, includes defining a plurality of visible wavelength color data channels based at least on color data from the image data. The ISP pipeline may use the color data as input to a series of image color data channel processing stages. Within the plurality of image color data channel processing stages, the color data may be mapped into distinct logical color channels, each having a processing path through the image color data channel processing stages. As the color data in the color channels propagates through the image color data channel processing stages, each stage applies a filter, transformation, or other adjustment to the color channels, with the processed color channel output of a preceding stage providing the color channel input for the next stage in the image color data channel processing stage sequence of the ISP pipeline.

Method 300, at block B306, includes propagating at least one control channel through at least one processing stage of the one or more image processing stages of the ISP, the at least one control channel being determined based on non-visible wavelength IR data from the image data. The control channel, such as IR-based control channel 126, may comprise an up-sampled mapping of the non-visible wavelength data (e.g., IR data) from the image data. The control channel may include non-visible wavelength IR image data and/or a channel based on data derived from non-visible wavelength IR image data (e.g., PR data-based image, image statistics, and/or a control channel coefficient, C). In some embodiments, the at least one control channel may be generated based at least on a difference between a brightness of the plurality of visible wavelength color data channels and a brightness of the non-visible wavelength IR data. In some embodiments, the at least one control channel may be based at least on a pseudo-radiometric (PR) channel computed as a weighted sum of one or more individual color channels of the plurality of visible wavelength color data channels and the non-visible wavelength IR data from the image data.

Method 300, at block B308, includes applying, at the one or more image processing stages, one or more adjustments to the visible wavelength color data channels using one or more image modulators determined at least in part from the at least one control channel. In some embodiments, the one or more image modulators may be computed based at least on channel statistics associated with the at least one control channel and the plurality of visible wavelength color data channels. The particular processing applied to the visible wavelength color data channels by an image color data channel processing stage may be controlled using image modulators associated with the processing performed by that stage (e.g., demosaicing, white balance, noise reduction, and so forth, as described herein), where the image modulators may be derived at least in part from the IR-based control channel that is propagated through the ISP pipeline to the image color data channel processing stages.

The one or more adjustments may be applied to the visible wavelength color data channels based on correlating structural data from the at least one control channel with structural data from the plurality of visible wavelength color data channels. Based at least on the one or more image modulators, one or more adjustments to the visible wavelength color data channels may include an adjustment associated with one or more of white balance, tone mapping, demosaicing, color noise reduction, color correction, image sharpening, and/or image scaling. In some embodiments, an output from the ISP may be generated based on the plurality of visible wavelength color data channels, as adjusted by the one or more image processing stages. Such an output may be used to render a visualization 165 such as described with respect to FIG. 1. In some embodiments, an output from the ISP may be generated based on the at least one control channel. Such an output may be used to assess one or more elements of a scene represented by the image data based at least on one or more image features represented by the at least one control channel.

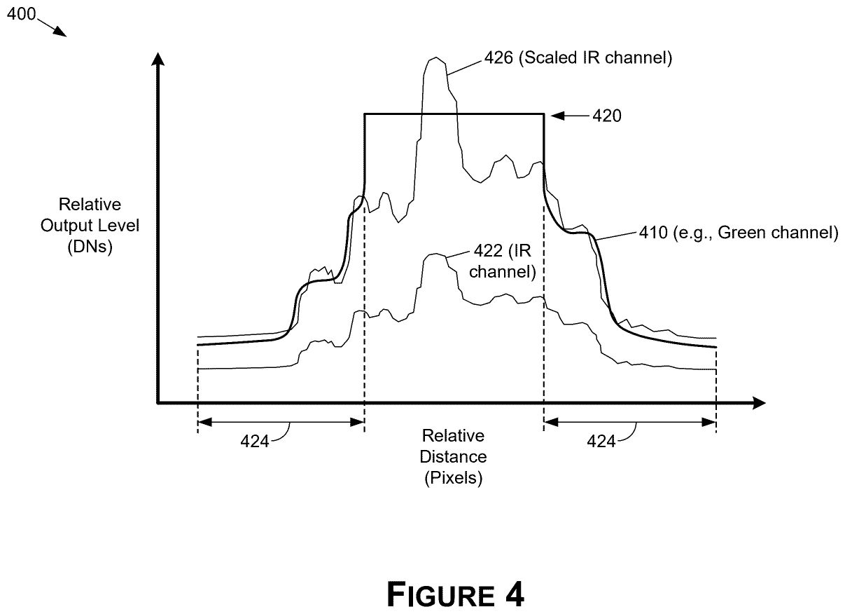

As an example, in some embodiments, an image color data channel processing stage may implement a highlight recovery correction for a saturated visible wavelength color data channel based on non-visible wavelength IR data. To illustrate, FIG. 4 is a diagram 400 correlating and scaling non-visible wavelength IR data provided by a control channel to replace saturated pixels. In FIG. 4, a color data channel comprising color and IR data 410 is saturated, as shown at 420. The IR data channel, shown at 422, is not saturated. Accordingly, for pixels in an unsaturated region adjacent to the saturated color and IR pixels (shown at 424), a color IR-corrected signal (a color channel where the IR data has been removed) may be correlated with the IR data channel in the unsaturated region 424. The IR channel may be scaled (shown by scaled IR signal 426), and the value of the scaled IR channel 426 in the saturated region used to replace the value of saturated pixels in the color+IR data channel 420. That is, for a first pixel of the image data, an image color data channel processing stage may determine when at least one color channel from the plurality of visible wavelength color data channels is saturated; determine an output level corresponding to the non-visible wavelength IR data for a second pixel of the image data where a color channel corresponding to the at least one color channel is not saturated; and correct the at least one color channel for the first pixel based on the output level corresponding to the non-visible wavelength IR data for the second pixel.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs) and/or one or more vision language models (VLMs), systems for performing light transport simulation, systems for performing collaborative content creation for 3D assets, systems implemented at least partially using cloud computing resources, and/or other types of systems.

### EXAMPLE AUTONOMOUS VEHICLE

FIG. 5A is an illustration of an example autonomous vehicle 500, in accordance with some embodiments of the present disclosure. The autonomous vehicle 500 (alternatively referred to herein as the “vehicle 500”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 500 may be capable of functionality in accordance with one or more of Level 3-Level 5 of the autonomous driving levels. The vehicle 500 may be capable of functionality in accordance with one or more of Level 1-Level 5 of the autonomous driving levels. For example, the vehicle 500 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 500 or other machine, such as being fully autonomous, being highly autonomous, being conditionally autonomous, being partially autonomous, providing assistive autonomy, being semi-autonomous, being primarily autonomous, or other designation.

The vehicle 500 may include components such as a chassis, a vehicle body, wheels (e.g., 2, 4, 6, 8, 18, etc.), tires, axles, and other components of a vehicle. The vehicle 500 may include a propulsion system 550, such as an internal combustion engine, hybrid electric power plant, an all-electric engine, and/or another propulsion system type. The propulsion system 550 may be connected to a drive train of the vehicle 500, which may include a transmission, to enable the propulsion of the vehicle 500. The propulsion system 550 may be controlled in response to receiving signals from the throttle/accelerator 552.

A steering system 554, which may include a steering wheel, may be used to steer the vehicle 500 (e.g., along a desired path or route) when the propulsion system 550 is operating (e.g., when the vehicle is in motion). The steering system 554 may receive signals from a steering actuator 556. The steering wheel may be optional for full automation (Level 5) functionality.

The brake sensor system 546 may be used to operate the vehicle brakes in response to receiving signals from the brake actuators 548 and/or brake sensors.

Controller(s) 536, which may include one or more system on chips (SoCs) 504 (FIG. 5C) and/or GPU(s), may provide signals (e.g., representative of commands) to one or more components and/or systems of the vehicle 500. For example, the controller(s) may send signals to operate the vehicle brakes via one or more brake actuators 548, to operate the steering system 554 via one or more steering actuators 556, to operate the propulsion system 550 via one or more throttle/accelerators 552. The controller(s) 536 may include one or more onboard (e.g., integrated) computing devices (e.g., supercomputers) that process sensor signals, and output operation commands (e.g., signals representing commands) to enable autonomous driving and/or to assist a human driver in driving the vehicle 500. The controller(s) 536 may include a first controller 536 for autonomous driving functions, a second controller 536 for functional safety functions, a third controller 536 for artificial intelligence functionality (e.g., computer vision), a fourth controller 536 for infotainment functionality, a fifth controller 536 for redundancy in emergency conditions, and/or other controllers. In some examples, a single controller 536 may handle two or more of the above functionalities, two or more controllers 536 may handle a single functionality, and/or any combination thereof. In some embodiments, one or more aspects of the image signal processor 120 may be implemented by code executed by the controller(s) 536.

The controller(s) 536 may provide the signals for controlling one or more components and/or systems of the vehicle 500 in response to sensor data received from one or more sensors (e.g., sensor inputs). The sensor data may be received from, for example and without limitation, global navigation satellite systems (“GNSS”) sensor(s) 558 (e.g., Global Positioning System sensor(s)), RADAR sensor(s) 560, ultrasonic sensor(s) 562, LIDAR sensor(s) 564, inertial measurement unit (IMU) sensor(s) 566 (e.g., accelerometer(s), gyroscope(s), magnetic compass(es), magnetometer(s), etc.), microphone(s) 596, stereo camera(s) 568, wide-view camera(s) 570 (e.g., fisheye cameras), infrared camera(s) 572, surround camera(s) 574 (e.g., 360 degree cameras), long-range and/or mid-range camera(s) 598, speed sensor(s) 544 (e.g., for measuring the speed of the vehicle 500), vibration sensor(s) 542, steering sensor(s) 540, brake sensor(s) (e.g., as part of the brake sensor system 546), one or more occupant monitoring system (OMS) sensor(s) 501 (e.g., one or more interior cameras), and/or other sensor types.

One or more of the controller(s) 536 may receive inputs (e.g., represented by input data) from an instrument cluster 532 of the vehicle 500 and provide outputs (e.g., represented by output data, display data, etc.) via a human-machine interface (HMI) display 534, an audible annunciator, a loudspeaker, and/or via other components of the vehicle 500. The outputs may include information such as vehicle velocity, speed, time, map data (e.g., the High Definition (“HD”) map 522 of FIG. 5C), location data (e.g., the vehicle's 500 location, such as on a map), direction, location of other vehicles (e.g., an occupancy grid), information about objects and status of objects as perceived by the controller(s) 536, etc. For example, the HMI display 534 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.). In some embodiments, visualization 165 may be presented on HMI display 537

The vehicle 500 further includes a network interface 524 which may use one or more wireless antenna(s) 526 and/or modem(s) to communicate over one or more networks. For example, the network interface 524 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 526 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 5B is an example of camera locations and fields of view for the example autonomous vehicle 500 of FIG. 5A, in accordance with some embodiments of the present disclosure. The cameras and respective fields of view are one example embodiment and are not intended to be limiting. For example, additional and/or alternative cameras may be included and/or the cameras may be located at different locations on the vehicle 500. In some embodiments, image sensor(s) 105 may be implemented using one or more of the cameras described with respect to FIGS. 1A and 1B.

The camera types for the cameras may include, but are not limited to, digital cameras that may be adapted for use with the components and/or systems of the vehicle 500. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously. In some embodiments image data may include processed image data 140.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 500 (e.g., front-facing cameras) may be used for surround view, to help identify forward facing paths and obstacles, as well aid in, with the help of one or more controllers 536 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 570 that may be used to perceive objects coming into view from the periphery (e.g., pedestrians, crossing traffic or bicycles). Although only one wide-view camera is illustrated in FIG. 5B, there may be any number (including zero) of wide-view cameras 570 on the vehicle 500. In addition, any number of long-range camera(s) 598 (e.g., a long-view stereo camera pair) may be used for depth-based object detection, especially for objects for which a neural network has not yet been trained. The long-range camera(s) 598 may also be used for object detection and classification, as well as basic object tracking.

Any number of stereo cameras 568 may also be included in a front-facing configuration. In at least one embodiment, one or more of stereo camera(s) 568 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 568 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 568 may be used in addition to, or alternatively from, those described herein.

Cameras with a field of view that include portions of the environment to the side of the vehicle 500 (e.g., side-view cameras) may be used for surround view, providing information used to create and update the occupancy grid, as well as to generate side impact collision warnings. For example, surround camera(s) 574 (e.g., four surround cameras 574 as illustrated in FIG. 5B) may be positioned to on the vehicle 500. The surround camera(s) 574 may include wide-view camera(s) 570, fisheye camera(s), 360 degree camera(s), and/or the like. Four example, four fisheye cameras may be positioned on the vehicle's front, rear, and sides. In an alternative arrangement, the vehicle may use three surround camera(s) 574 (e.g., left, right, and rear), and may leverage one or more other camera(s) (e.g., a forward-facing camera) as a fourth surround view camera.

Cameras with a field of view that include portions of the environment to the rear of the vehicle 500 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 598, stereo camera(s) 568), infrared camera(s) 572, etc.), as described herein.

Cameras with a field of view that include portions of the interior environment within the cabin of the vehicle 500 (e.g., one or more OMS sensor(s) 501) may be used as part of an occupant monitoring system (OMS) such as, but not limited to, a driver monitoring system (DMS). For example, OMS sensors (e.g., the OMS sensor(s) 501) may be used (e.g., by the controller(s) 536) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to enable gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 5C is a block diagram of an example system architecture for the example autonomous vehicle 500 of FIG. 5A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 500 in FIG. 5C are illustrated as being connected via bus 502. The bus 502 may include a Controller Area Network (CAN) data interface (alternatively referred to herein as a “CAN bus”). A CAN may be a network inside the vehicle 500 used to aid in control of various features and functionality of the vehicle 500, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 502 is described herein as being a CAN bus, this is not intended to be limiting. For example, in addition to, or alternatively from, the CAN bus, FlexRay and/or Ethernet may be used. Additionally, although a single line is used to represent the bus 502, this is not intended to be limiting. For example, there may be any number of busses 502, which may include one or more CAN busses, one or more FlexRay busses, one or more Ethernet busses, and/or one or more other types of busses using a different protocol. In some examples, two or more busses 502 may be used to perform different functions, and/or may be used for redundancy. For example, a first bus 502 may be used for collision avoidance functionality and a second bus 502 may be used for actuation control. In any example, each bus 502 may communicate with any of the components of the vehicle 500, and two or more busses 502 may communicate with the same components. In some examples, each SoC 504, each controller 536, and/or each computer within the vehicle may have access to the same input data (e.g., inputs from sensors of the vehicle 500), and may be connected to a common bus, such the CAN bus.

The vehicle 500 may include one or more controller(s) 536, such as those described herein with respect to FIG. 5A. The controller(s) 536 may be used for a variety of functions. The controller(s) 536 may be coupled to any of the various other components and systems of the vehicle 500, and may be used for control of the vehicle 500, artificial intelligence of the vehicle 500, infotainment for the vehicle 500, and/or the like.

The vehicle 500 may include a system(s) on a chip (SoC) 504. The SoC 504 may include CPU(s) 506, GPU(s) 508, processor(s) 510, cache(s) 512, accelerator(s) 514, data store(s) 516, and/or other components and features not illustrated. The SoC(s) 504 may be used to control the vehicle 500 in a variety of platforms and systems. For example, the SoC(s) 504 may be combined in a system (e.g., the system of the vehicle 500) with an HD map 522 which may obtain map refreshes and/or updates via a network interface 524 from one or more servers (e.g., server(s) 578 of FIG. 5D). In some embodiments, one or more aspects of the image signal processor 120 may be implemented by code executed by a SoC 504.

The CPU(s) 506 may include a CPU cluster or CPU complex (alternatively referred to herein as a “CCPLEX”). The CPU(s) 506 may include multiple cores and/or L2 caches. For example, in some embodiments, the CPU(s) 506 may include eight cores in a coherent multi-processor configuration. In some embodiments, the CPU(s) 506 may include four dual-core clusters where each cluster has a dedicated L2 cache (e.g., a 2 MB L2 cache). The CPU(s) 506 (e.g., the CCPLEX) may be configured to support simultaneous cluster operation enabling any combination of the clusters of the CPU(s) 506 to be active at any given time.

The CPU(s) 506 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 506 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 508 may include an integrated GPU (alternatively referred to herein as an “iGPU”). The GPU(s) 508 may be programmable and may be efficient for parallel workloads. The GPU(s) 508, in some examples, may use an enhanced tensor instruction set. The GPU(s) 508 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 508 may include at least eight streaming microprocessors. The GPU(s) 508 may use compute application programming interface(s) (API(s)). In addition, the GPU(s) 508 may use one or more parallel computing platforms and/or programming models (e.g., NVIDIA's CUDA).

The GPU(s) 508 may be power-optimized for best performance in automotive and embedded use cases. For example, the GPU(s) 508 may be fabricated on a Fin field-effect transistor (FinFET). However, this is not intended to be limiting and the GPU(s) 508 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an LO instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined LI data cache and shared memory unit in order to improve performance while simplifying programming.

The GPU(s) 508 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 508 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 508 to access the CPU(s) 506 page tables directly. In such examples, when the GPU(s) 508 memory management unit (MMU) experiences a miss, an address translation request may be transmitted to the CPU(s) 506. In response, the CPU(s) 506 may look in its page tables for the virtual-to-physical mapping for the address and transmits the translation back to the GPU(s) 508. As such, unified memory technology may allow a single unified virtual address space for memory of both the CPU(s) 506 and the GPU(s) 508, thereby simplifying the GPU(s) 508 programming and porting of applications to the GPU(s) 508.

In addition, the GPU(s) 508 may include an access counter that may keep track of the frequency of access of the GPU(s) 508 to memory of other processors. The access counter may help ensure that memory pages are moved to the physical memory of the processor that is accessing the pages most frequently.

The SoC(s) 504 may include any number of cache(s) 512, including those described herein. For example, the cache(s) 512 may include an L3 cache that is available to both the CPU(s) 506 and the GPU(s) 508 (e.g., that is connected both the CPU(s) 506 and the GPU(s) 508). The cache(s) 512 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 504 may include an arithmetic logic unit(s) (ALU(s)) which may be leveraged in performing processing with respect to any of the variety of tasks or operations of the vehicle 500—such as processing DNNs. In addition, the SoC(s) 504 may include a floating point unit(s) (FPU(s))—or other math coprocessor or numeric coprocessor types—for performing mathematical operations within the system. For example, the SoC(s) 504 may include one or more FPUs integrated as execution units within a CPU(s) 506 and/or GPU(s) 508.

The SoC(s) 504 may include one or more accelerators 514 (e.g., hardware accelerators, software accelerators, or a combination thereof). For example, the SoC(s) 504 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 508 and to off-load some of the tasks of the GPU(s) 508 (e.g., to free up more cycles of the GPU(s) 508 for performing other tasks). As an example, the accelerator(s) 514 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 514 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 508, and by using an inference accelerator, for example, a designer may target either the DLA(s) or the GPU(s) 508 for any function. For example, the designer may focus processing of CNNs and floating point operations on the DLA(s) and leave other functions to the GPU(s) 508 and/or other accelerator(s) 514.

The accelerator(s) 514 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 506. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 514 (e.g., the hardware acceleration cluster) may include a computer vision network on-chip and SRAM, for providing a high-bandwidth, low latency SRAM for the accelerator(s) 514. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 504 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 514 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 566 output that correlates with the vehicle 500 orientation, distance, 3D location estimates of the object obtained from the neural network and/or other sensors (e.g., LIDAR sensor(s) 564 or RADAR sensor(s) 560), among others.

The SoC(s) 504 may include data store(s) 516 (e.g., memory). The data store(s) 516 may be on-chip memory of the SoC(s) 504, which may store neural networks to be executed on the GPU and/or the DLA. In some examples, the data store(s) 516 may be large enough in capacity to store multiple instances of neural networks for redundancy and safety. The data store(s) 516 may comprise L2 or L3 cache(s) 512. Reference to the data store(s) 516 may include reference to the memory associated with the PVA, DLA, and/or other accelerator(s) 514, as described herein.

The SoC(s) 504 may include one or more processor(s) 510 (e.g., embedded processors). The processor(s) 510 may include a boot and power management processor that may be a dedicated processor and subsystem to handle boot power and management functions and related security enforcement. The boot and power management processor may be a part of the SoC(s) 504 boot sequence and may provide runtime power management services. The boot power and management processor may provide clock and voltage programming, assistance in system low power state transitions, management of SoC(s) 504 thermals and temperature sensors, and/or management of the SoC(s) 504 power states. Each temperature sensor may be implemented as a ring-oscillator whose output frequency is proportional to temperature, and the SoC(s) 504 may use the ring-oscillators to detect temperatures of the CPU(s) 506, GPU(s) 508, and/or accelerator(s) 514. If temperatures are determined to exceed a threshold, the boot and power management processor may enter a temperature fault routine and put the SoC(s) 504 into a lower power state and/or put the vehicle 500 into a chauffeur to safe stop mode (e.g., bring the vehicle 500 to a safe stop).

The processor(s) 510 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 510 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 510 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 510 may further include a real-time camera engine that may include a dedicated processor subsystem for handling real-time camera management.

The processor(s) 510 may further include a high-dynamic range signal processor that may include an image signal processor that is a hardware engine that is part of the camera processing pipeline.

The processor(s) 510 may include a video image compositor that may be a processing block (e.g., implemented on a microprocessor) that implements video post-processing functions needed by a video playback application to produce the final image for the player window. The video image compositor may perform lens distortion correction on wide-view camera(s) 570, surround camera(s) 574, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 508 is not required to continuously render new surfaces. Even when the GPU(s) 508 is powered on and active doing 3D rendering, the video image compositor may be used to offload the GPU(s) 508 to improve performance and responsiveness.

The SoC(s) 504 may further include a mobile industry processor interface (MIPI) camera serial interface for receiving video and input from cameras, a high-speed interface, and/or a video input block that may be used for camera and related pixel input functions. The SoC(s) 504 may further include an input/output controller(s) that may be controlled by software and may be used for receiving I/O signals that are uncommitted to a specific role.

The SoC(s) 504 may further include a broad range of peripheral interfaces to enable communication with peripherals, audio codecs, power management, and/or other devices. The SoC(s) 504 may be used to process data from cameras (e.g., connected over Gigabit Multimedia Serial Link and Ethernet), sensors (e.g., LIDAR sensor(s) 564, RADAR sensor(s) 560, etc. that may be connected over Ethernet), data from bus 502 (e.g., speed of vehicle 500, steering wheel position, etc.), data from GNSS sensor(s) 558 (e.g., connected over Ethernet or CAN bus). The SoC(s) 504 may further include dedicated high-performance mass storage controllers that may include their own DMA engines, and that may be used to free the CPU(s) 506 from routine data management tasks.

The SoC(s) 504 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 504 may be faster, more reliable, and even more energy-efficient and space-efficient than conventional systems. For example, the accelerator(s) 514, when combined with the CPU(s) 506, the GPU(s) 508, and the data store(s) 516, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 520) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 508.

In some examples, a CNN for facial recognition and vehicle owner identification may use data from camera sensors to identify the presence of an authorized driver and/or owner of the vehicle 500. The always on sensor processing engine may be used to unlock the vehicle when the owner approaches the driver door and turn on the lights, and, in security mode, to disable the vehicle when the owner leaves the vehicle. In this way, the SoC(s) 504 provide for security against theft and/or carjacking.

In another example, a CNN for emergency vehicle detection and identification may use data from microphones 596 to detect and identify emergency vehicle sirens. In contrast to conventional systems, that use general classifiers to detect sirens and manually extract features, the SoC(s) 504 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 558. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 562, until the emergency vehicle(s) passes.

The vehicle may include a CPU(s) 518 (e.g., discrete CPU(s), or dCPU(s)), that may be coupled to the SoC(s) 504 via a high-speed interconnect (e.g., PCIe). The CPU(s) 518 may include an X86 processor, for example. The CPU(s) 518 may be used to perform any of a variety of functions, including arbitrating potentially inconsistent results between ADAS sensors and the SoC(s) 504, and/or monitoring the status and health of the controller(s) 536 and/or infotainment SoC 530, for example.

The vehicle 500 may include a GPU(s) 520 (e.g., discrete GPU(s), or dGPU(s)), that may be coupled to the SoC(s) 504 via a high-speed interconnect (e.g., NVIDIA's NVLINK). The GPU(s) 520 may provide additional artificial intelligence functionality, such as by executing redundant and/or different neural networks, and may be used to train and/or update neural networks based on input (e.g., sensor data) from sensors of the vehicle 500.

The vehicle 500 may further include the network interface 524 which may include one or more wireless antennas 526 (e.g., one or more wireless antennas for different communication protocols, such as a cellular antenna, a Bluetooth antenna, etc.). The network interface 524 may be used to enable wireless connectivity over the Internet with the cloud (e.g., with the server(s) 578 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 500 information about vehicles in proximity to the vehicle 500 (e.g., vehicles in front of, on the side of, and/or behind the vehicle 500). This functionality may be part of a cooperative adaptive cruise control functionality of the vehicle 500.

The network interface 524 may include a SoC that provides modulation and demodulation functionality and enables the controller(s) 536 to communicate over wireless networks. The network interface 524 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 500 may further include data store(s) 528 which may include off-chip (e.g., off the SoC(s) 504) storage. The data store(s) 528 may include one or more storage elements including RAM, SRAM, DRAM, VRAM, Flash, hard disks, and/or other components and/or devices that may store at least one bit of data.

The vehicle 500 may further include GNSS sensor(s) 558. The GNSS sensor(s) 558 (e.g., GPS, assisted GPS sensors, differential GPS (DGPS) sensors, etc.), to assist in mapping, perception, occupancy grid generation, and/or path planning functions. Any number of GNSS sensor(s) 558 may be used, including, for example and without limitation, a GPS using a USB connector with an Ethernet to Serial (RS-232) bridge.

The vehicle 500 may further include RADAR sensor(s) 560. The RADAR sensor(s) 560 may be used by the vehicle 500 for long-range vehicle detection, even in darkness and/or severe weather conditions. RADAR functional safety levels may be ASIL B. The RADAR sensor(s) 560 may use the CAN and/or the bus 502 (e.g., to transmit data generated by the RADAR sensor(s) 560) for control and to access object tracking data, with access to Ethernet to access raw data in some examples. A wide variety of RADAR sensor types may be used. For example, and without limitation, the RADAR sensor(s) 560 may be suitable for front, rear, and side RADAR use. In some example, Pulse Doppler RADAR sensor(s) are used.

The RADAR sensor(s) 560 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 560 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 500 surroundings at higher speeds with minimal interference from traffic in adjacent lanes. The other two antennae may expand the field of view, making it possible to quickly detect vehicles entering or leaving the vehicle's 500 lane.

Mid-range RADAR systems may include, as an example, a range of up to 560 m (front) or 80 m (rear), and a field of view of up to 42 degrees (front) or 550 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 500 may further include ultrasonic sensor(s) 562. The ultrasonic sensor(s) 562, which may be positioned at the front, back, and/or the sides of the vehicle 500, may be used for park assist and/or to create and update an occupancy grid. A wide variety of ultrasonic sensor(s) 562 may be used, and different ultrasonic sensor(s) 562 may be used for different ranges of detection (e.g., 2.5 m, 4 m). The ultrasonic sensor(s) 562 may operate at functional safety levels of ASIL B.

The vehicle 500 may include LIDAR sensor(s) 564. The LIDAR sensor(s) 564 may be used for object and pedestrian detection, emergency braking, collision avoidance, and/or other functions. The LIDAR sensor(s) 564 may be functional safety level ASIL B. In some examples, the vehicle 500 may include multiple LIDAR sensors 564 (e.g., two, four, six, etc.) that may use Ethernet (e.g., to provide data to a Gigabit Ethernet switch).

In some examples, the LIDAR sensor(s) 564 may be capable of providing a list of objects and their distances for a 360-degree field of view. Commercially available LIDAR sensor(s) 564 may have an advertised range of approximately 500 m, with an accuracy of 2 cm-3 cm, and with support for a 500 Mbps Ethernet connection, for example. In some examples, one or more non-protruding LIDAR sensors 564 may be used. In such examples, the LIDAR sensor(s) 564 may be implemented as a small device that may be embedded into the front, rear, sides, and/or corners of the vehicle 500. The LIDAR sensor(s) 564, in such examples, may provide up to a 120-degree horizontal and 35-degree vertical field-of-view, with a 200 m range even for low-reflectivity objects. Front-mounted LIDAR sensor(s) 564 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 500. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 564 may be less susceptible to motion blur, vibration, and/or shock.

The vehicle may further include IMU sensor(s) 566. The IMU sensor(s) 566 may be located at a center of the rear axle of the vehicle 500, in some examples. The IMU sensor(s) 566 may include, for example and without limitation, an accelerometer(s), a magnetometer(s), a gyroscope(s), a magnetic compass(es), and/or other sensor types. In some examples, such as in six-axis applications, the IMU sensor(s) 566 may include accelerometers and gyroscopes, while in nine-axis applications, the IMU sensor(s) 566 may include accelerometers, gyroscopes, and magnetometers.

In some embodiments, the IMU sensor(s) 566 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 566 may enable the vehicle 500 to estimate heading without requiring input from a magnetic sensor by directly observing and correlating the changes in velocity from GPS to the IMU sensor(s) 566. In some examples, the IMU sensor(s) 566 and the GNSS sensor(s) 558 may be combined in a single integrated unit.

The vehicle may include microphone(s) 596 placed in and/or around the vehicle 500. The microphone(s) 596 may be used for emergency vehicle detection and identification, among other things.

The vehicle may further include any number of camera types, including stereo camera(s) 568, wide-view camera(s) 570, infrared camera(s) 572, surround camera(s) 574, long-range and/or mid-range camera(s) 598, and/or other camera types. The cameras may be used to capture image data around an entire periphery of the vehicle 500. The types of cameras used depends on the embodiments and requirements for the vehicle 500, and any combination of camera types may be used to provide the necessary coverage around the vehicle 500. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 5A and FIG. 5B.

The vehicle 500 may further include vibration sensor(s) 542. The vibration sensor(s) 542 may measure vibrations of components of the vehicle, such as the axle(s). For example, changes in vibrations may indicate a change in road surfaces. In another example, when two or more vibration sensors 542 are used, the differences between the vibrations may be used to determine friction or slippage of the road surface (e.g., when the difference in vibration is between a power-driven axle and a freely rotating axle).

The vehicle 500 may include an ADAS system 538. The ADAS system 538 may include a SoC, in some examples. The ADAS system 538 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 560, LIDAR sensor(s) 564, and/or a camera(s). The ACC systems may include longitudinal ACC and/or lateral ACC. Longitudinal ACC monitors and controls the distance to the vehicle immediately ahead of the vehicle 500 and automatically adjust the vehicle speed to maintain a safe distance from vehicles ahead. Lateral ACC performs distance keeping, and advises the vehicle 500 to change lanes when necessary. Lateral ACC is related to other ADAS applications such as LCA and CWS.

CACC uses information from other vehicles that may be received via the network interface 524 and/or the wireless antenna(s) 526 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 500), while the I2V communication concept provides information about traffic further ahead. CACC systems may include either or both I2V and V2V information sources. Given the information of the vehicles ahead of the vehicle 500, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 560, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 560, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 500 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 500 if the vehicle 500 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 560, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 500 is backing up. Some RCTW systems include AEB to ensure that the vehicle brakes are applied to avoid a crash. RCTW systems may use one or more rear-facing RADAR sensor(s) 560, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 500, the vehicle 500 itself must, in the case of conflicting results, decide whether to heed the result from a primary computer or a secondary computer (e.g., a first controller 536 or a second controller 536). For example, in some embodiments, the ADAS system 538 may be a backup and/or secondary computer for providing perception information to a backup computer rationality module. The backup computer rationality monitor may run a redundant diverse software on hardware components to detect faults in perception and dynamic driving tasks. Outputs from the ADAS system 538 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 504.

In other examples, ADAS system 538 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 538 may be fed into the primary computer's perception block and/or the primary computer's dynamic driving task block. For example, if the ADAS system 538 indicates a forward crash warning due to an object immediately ahead, the perception block may use this information when identifying objects. In other examples, the secondary computer may have its own neural network which is trained and thus reduces the risk of false positives, as described herein.

The vehicle 500 may further include the infotainment SoC 530 (e.g., an in-vehicle infotainment system (IVI)). Although illustrated and described as a SoC, the infotainment system may not be a SoC, and may include two or more discrete components. The infotainment SoC 530 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 500. For example, the infotainment SoC 530 may radios, disk players, navigation systems, video players, USB and Bluetooth connectivity, carputers, in-car entertainment, Wi-Fi, steering wheel audio controls, hands free voice control, a heads-up display (HUD), an HMI display 534, a telematics device, a control panel (e.g., for controlling and/or interacting with various components, features, and/or systems), and/or other components. The infotainment SoC 530 may further be used to provide information (e.g., visual and/or audible) to a user(s) of the vehicle, such as information from the ADAS system 538, autonomous driving information such as planned vehicle maneuvers, trajectories, surrounding environment information (e.g., intersection information, vehicle information, road information, etc.), and/or other information.

The infotainment SoC 530 may include GPU functionality. The infotainment SoC 530 may communicate over the bus 502 (e.g., CAN bus, Ethernet, etc.) with other devices, systems, and/or components of the vehicle 500. In some examples, the infotainment SoC 530 may be coupled to a supervisory MCU such that the GPU of the infotainment system may perform some self-driving functions in the event that the primary controller(s) 536 (e.g., the primary and/or backup computers of the vehicle 500) fail. In such an example, the infotainment SoC 530 may put the vehicle 500 into a chauffeur to safe stop mode, as described herein.

The vehicle 500 may further include an instrument cluster 532 (e.g., a digital dash, an electronic instrument cluster, a digital instrument panel, etc.). The instrument cluster 532 may include a controller and/or supercomputer (e.g., a discrete controller or supercomputer). The instrument cluster 532 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 530 and the instrument cluster 532. In other words, the instrument cluster 532 may be included as part of the infotainment SoC 530, or vice versa.

FIG. 5D is a system diagram for communication between cloud-based server(s) and the example autonomous vehicle 500 of FIG. 5A, in accordance with some embodiments of the present disclosure. The system 576 may include server(s) 578, network(s) 590, and vehicles, including the vehicle 500. The server(s) 578 may include a plurality of GPUs 584(A)-584(H) (collectively referred to herein as GPUs 584), PCIe switches 582(A)-582(D) (collectively referred to herein as PCle switches 582), and/or CPUs 580(A)-580(B) (collectively referred to herein as CPUs 580). The GPUs 584, the CPUs 580, and the PCle switches may be interconnected with high-speed interconnects such as, for example and without limitation, NVLink interfaces 588 developed by NVIDIA and/or PCle connections 586. In some examples, the GPUs 584 are connected via NVLink and/or NVSwitch SoC and the GPUs 584 and the PCle switches 582 are connected via PCIe interconnects. Although eight GPUs 584, two CPUs 580, and two PCle switches are illustrated, this is not intended to be limiting. Depending on the embodiment, each of the server(s) 578 may include any number of GPUs 584, CPUs 580, and/or PCle switches. For example, the server(s) 578 may each include eight, sixteen, thirty-two, and/or more GPUs 584.

The server(s) 578 may receive, over the network(s) 590 and from the vehicles, image data representative of images showing unexpected or changed road conditions, such as recently commenced road-work. The server(s) 578 may transmit, over the network(s) 590 and to the vehicles, neural networks 592, updated neural networks 592, and/or map information 594, including information regarding traffic and road conditions. The updates to the map information 594 may include updates for the HD map 522, such as information regarding construction sites, potholes, detours, flooding, and/or other obstructions. In some examples, the neural networks 592, the updated neural networks 592, and/or the map information 594 may have resulted from new training and/or experiences represented in data received from any number of vehicles in the environment, and/or based on training performed at a datacenter (e.g., using the server(s) 578 and/or other servers).

The server(s) 578 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 590, and/or the machine learning models may be used by the server(s) 578 to remotely monitor the vehicles.

In some examples, the server(s) 578 may receive data from the vehicles and apply the data to up-to-date real-time neural networks for real-time intelligent inferencing. The server(s) 578 may include deep-learning supercomputers and/or dedicated AI computers powered by GPU(s) 584, such as a DGX and DGX Station machines developed by NVIDIA. However, in some examples, the server(s) 578 may include deep learning infrastructure that use only CPU-powered datacenters.

The deep-learning infrastructure of the server(s) 578 may be capable of fast, real-time inferencing, and may use that capability to evaluate and verify the health of the processors, software, and/or associated hardware in the vehicle 500. For example, the deep-learning infrastructure may receive periodic updates from the vehicle 500, such as a sequence of images and/or objects that the vehicle 500 has located in that sequence of images (e.g., via computer vision and/or other machine learning object classification techniques). The deep-learning infrastructure may run its own neural network to identify the objects and compare them with the objects identified by the vehicle 500 and, if the results do not match and the infrastructure concludes that the AI in the vehicle 500 is malfunctioning, the server(s) 578 may transmit a signal to the vehicle 500 instructing a fail-safe computer of the vehicle 500 to assume control, notify the passengers, and complete a safe parking maneuver.

For inferencing, the server(s) 578 may include the GPU(s) 584 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### EXAMPLE COMPUTING DEVICE

FIG. 6 is a block diagram of an example computing device(s) 600 suitable for use in implementing some embodiments of the present disclosure. Computing device 600 may include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one embodiment, the computing device(s) 600 may comprise one or more virtual machines (VMs), and/or any of the components thereof may comprise virtual components (e.g., virtual hardware components). For non-limiting examples, one or more of the GPUs 608 may comprise one or more vGPUs, one or more of the CPUs 606 may comprise one or more vCPUs, and/or one or more of the logic units 620 may comprise one or more virtual logic units. As such, a computing device(s) 600 may include discrete components (e.g., a full GPU dedicated to the computing device 600), virtual components (e.g., a portion of a GPU dedicated to the computing device 600), or a combination thereof. In some embodiments, one or more aspects of the image signal processor 120 may be implemented by code executed by one or more of CPUs 606 and/or GPUs 608.

Although the various blocks of FIG. 6 are shown as connected via the interconnect system 602 with lines, this is not intended to be limiting and is for clarity only. For example, in some embodiments, a presentation component 618, such as a display device, may be considered an I/O component 614 (e.g., if the display is a touch screen). As another example, the CPUs 606 and/or GPUs 608 may include memory (e.g., the memory 604 may be representative of a storage device in addition to the memory of the GPUs 608, the CPUs 606, and/or other components). In other words, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 may represent one or more links or busses, such as an address bus, a data bus, a control bus, or a combination thereof. The interconnect system 602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 606 may be directly connected to the memory 604. Further, the CPU 606 may be directly connected to the GPU 608. Where there is direct, or point-to-point connection between components, the interconnect system 602 may include a PCIe link to carry out the connection. In these examples, a PCI bus need not be included in the computing device 600.

The memory 604 may include any of a variety of computer-readable media. The computer-readable media may be any available media that may be accessed by the computing device 600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 606 may be configured to execute at least some of the computer-readable instructions to control one or more components of the computing device 600 to perform one or more of the methods and/or processes described herein. The CPU(s) 606 may each include one or more cores (e.g., one, two, four, eight, twenty-eight, seventy-two, etc.) that are capable of handling a multitude of software threads simultaneously. The CPU(s) 606 may include any type of processor, and may include different types of processors depending on the type of computing device 600 implemented (e.g., processors with fewer cores for mobile devices and processors with more cores for servers). For example, depending on the type of computing device 600, the processor may be an Advanced RISC Machines (ARM) processor implemented using Reduced Instruction Set Computing (RISC) or an x86 processor implemented using Complex Instruction Set Computing (CISC). The computing device 600 may include one or more CPUs 606 in addition to one or more microprocessors or supplementary co-processors, such as math co-processors.

In addition to or alternatively from the CPU(s) 606, the GPU(s) 608 may be configured to execute at least some of the computer-readable instructions to control one or more components of the computing device 600 to perform one or more of the methods and/or processes described herein. One or more of the GPU(s) 608 may be an integrated GPU (e.g., with one or more of the CPU(s) 606 and/or one or more of the GPU(s) 608 may be a discrete GPU. In embodiments, one or more of the GPU(s) 608 may be a coprocessor of one or more of the CPU(s) 606. The GPU(s) 608 may be used by the computing device 600 to render graphics (e.g., 3D graphics) or perform general purpose computations. For example, the GPU(s) 608 may be used for General-Purpose computing on GPUs (GPGPU). The GPU(s) 608 may include hundreds or thousands of cores that are capable of handling hundreds or thousands of software threads simultaneously. The GPU(s) 608 may generate pixel data for output images in response to rendering commands (e.g., rendering commands from the CPU(s) 606 received via a host interface). The GPU(s) 608 may include graphics memory, such as display memory, for storing pixel data or any other suitable data, such as GPGPU data. The display memory may be included as part of the memory 604. The GPU(s) 608 may include two or more GPUs operating in parallel (e.g., via a link). The link may directly connect the GPUs (e.g., using NVLINK) or may connect the GPUs through a switch (e.g., using NVSwitch). When combined together, each GPU 608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 606 and/or the GPU(s) 608, the logic unit(s) 620 may be configured to execute at least some of the computer-readable instructions to control one or more components of the computing device 600 to perform one or more of the methods and/or processes described herein. In embodiments, the CPU(s) 606, the GPU(s) 608, and/or the logic unit(s) 620 may discretely or jointly perform any combination of the methods, processes and/or portions thereof. One or more of the logic units 620 may be part of and/or integrated in one or more of the CPU(s) 606 and/or the GPU(s) 608 and/or one or more of the logic units 620 may be discrete components or otherwise external to the CPU(s) 606 and/or the GPU(s) 608. In embodiments, one or more of the logic units 620 may be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 may include one or more receivers, transmitters, and/or transceivers that enable the computing device 600 to communicate with other computing devices via an electronic communication network, included wired and/or wireless communications. The communication interface 610 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 620 and/or communication interface 610 may include one or more data processing units (DPUs) to transmit data received over a network and/or through interconnect system 602 directly to (e.g., a memory of) one or more GPU(s) 608.

The I/O ports 612 may enable the computing device 600 to be logically coupled to other devices including the I/O components 614, the presentation component(s) 618, and/or other components, some of which may be built in to (e.g., integrated in) the computing device 600. Illustrative I/O components 614 include a microphone, mouse, keyboard, joystick, game pad, game controller, satellite dish, scanner, printer, wireless device, etc. The I/O components 614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 may be include depth cameras, such as stereoscopic camera systems, infrared camera systems, RGB camera systems, touchscreen technology, and combinations of these, for gesture detection and recognition. Additionally, the computing device 600 may include accelerometers or gyroscopes (e.g., as part of an inertia measurement unit (IMU)) that enable detection of motion. In some examples, the output of the accelerometers or gyroscopes may be used by the computing device 600 to render immersive augmented reality or virtual reality.

The power supply 616 may include a hard-wired power supply, a battery power supply, or a combination thereof. The power supply 616 may provide power to the computing device 600 to enable the components of the computing device 600 to operate.

The presentation component(s) 618 may include a display (e.g., a monitor, a touch screen, a television screen, a heads-up-display (HUD), other display types, or a combination thereof), speakers, and/or other presentation components. The presentation component(s) 618 may receive data from other components (e.g., the GPU(s) 608, the CPU(s) 606, DPUs, etc.), and output the data (e.g., as an image, video, sound, etc.). In some embodiments, visualization 165 may be presented on a display of the presentation component(s) 618.

### EXAMPLE DATA CENTER

FIG. 7 illustrates an example data center 700 that may be used in at least one embodiments of the present disclosure. The data center 700 may include a data center infrastructure layer 710, a framework layer 720, a software layer 730, and/or an application layer 740.

As shown in FIG. 7, the data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 716(1)-716(N) may correspond to a server having one or more of the above-mentioned computing resources. In addition, in some embodiments, the node C.R.s 716(1)-7161(N) may include one or more virtual components, such as vGPUs, vCPUs, and/or the like, and/or one or more of the node C.R.s 716(1)-716(N) may correspond to a virtual machine (VM). In some embodiments, one or more aspects of the image signal processor 120 may be implemented by code executed by one or more of the node C.R.s 716(1)-716(N).

In at least one embodiment, grouped computing resources 714 may include separate groupings of node C.R.s 716 housed within one or more racks (not shown), or many racks housed in data centers at various geographical locations (also not shown). Separate groupings of node C.R.s 716 within grouped computing resources 714 may include grouped compute, network, memory or storage resources that may be configured or allocated to support one or more workloads. In at least one embodiment, several node C.R.s 716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 712 may configure or otherwise control one or more node C.R.s 716(1)-716(N) and/or grouped computing resources 714. In at least one embodiment, resource orchestrator 712 may include a software design infrastructure (SDI) management entity for the data center 700. The resource orchestrator 712 may include hardware, software, or some combination thereof.

In at least one embodiment, as shown in FIG. 7, framework layer 720 may include a job scheduler 733, a configuration manager 734, a resource manager 736, and/or a distributed file system 738. The framework layer 720 may include a framework to support software 732 of software layer 730 and/or one or more application(s) 742 of application layer 740. The software 732 or application(s) 742 may respectively include web-based service software or applications, such as those provided by Amazon Web Services, Google Cloud and Microsoft Azure. The framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 733 may include a Spark driver to facilitate scheduling of workloads supported by various layers of data center 700. The configuration manager 734 may be capable of configuring different layers such as software layer 730 and framework layer 720 including Spark and distributed file system 738 for supporting large-scale data processing. The resource manager 736 may be capable of managing clustered or grouped computing resources mapped to or allocated for support of distributed file system 738 and job scheduler 733. In at least one embodiment, clustered or grouped computing resources may include grouped computing resource 714 at data center infrastructure layer 710. The resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. One or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. Self-modifying actions may relieve a data center operator of data center 700 from making possibly bad configuration decisions and possibly avoiding underutilized and/or poor performing portions of a data center.

The data center 700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 700. In at least one embodiment, trained or deployed machine learning models corresponding to one or more neural networks may be used to infer or predict information using resources described above with respect to the data center 700 by using weight parameters calculated through one or more training techniques, such as but not limited to those described herein.

In at least one embodiment, the data center 700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 600 of FIG. 6—e.g., each device may include similar components, features, and/or functionality of the computing device(s) 600. In addition, where backend devices (e.g., servers, NAS, etc.) are implemented, the backend devices may be included as part of a data center 700, an example of which is described in more detail herein with respect to FIG. 7.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments-in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 600 described herein with respect to FIG. 6. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more processing units to:
receive image data at an image signal processor (ISP) that includes one or more image processing stages;
define a plurality of visible wavelength color data channels based at least on color data from the image data;
propagate at least one control channel through at least one processing stage of the one or more image processing stages of the ISP, the at least one control channel being determined based on non-visible wavelength IR data from the image data; and
apply, at the one or more image processing stages, one or more adjustments to the visible wavelength color data channels using one or more image modulators determined at least in part from the at least one control channel.

2. The processor of claim 1, wherein the one or more processing units are further to:
generate the at least one control channel based at least on a difference between a brightness of the plurality of visible wavelength color data channels and a brightness of the non-visible wavelength IR data.

3. The processor of claim 1, wherein the one or more processing units are further to:
generate the at least one control channel based at least on a pseudo-radiometric (PR) channel computed as a weighted sum of one or more individual color channels of the plurality of visible wavelength color data channels, and the non-visible wavelength IR data from the image data.

4. The processor of claim 1, wherein the one or more processing units are further to:
compute the one or more image modulators based at least on channel statistics associated with the at least one control channel and the plurality of visible wavelength color data channels.

5. The processor of claim 1, wherein the one or more processing units are further to:
apply one or more adjustments to at least one of an IR channel or a pseudo-radiometric (PR) channel of the image data using the one or more image modulators determined at least in part from the at least one control channel.

6. The processor of claim 1, wherein the one or more processing units are further to:
receive the image data as an image stream from an optical image sensor.

7. The processor of claim 1, wherein the one or more processing units are further to:
generate an output from the ISP based on the plurality of visible wavelength color data channels as adjusted by the one or more image processing stages.

8. The processor of claim 1, wherein the one or more processing units are further to:
generate an output from the ISP based on the at least one control channel; and
use the output to assess one or more elements of a scene represented by the image data based at least on one or more image features represented by the at least one control channel.

9. The processor of claim 1, wherein the one or more processing units are further to:
apply the one or more adjustments to the visible wavelength color data channels based on correlating structural data from the at least one control channel with structural data from the plurality of visible wavelength color data channels.

10. The processor of claim 1, wherein the one or more processing units are further to:
based at least on the one or more image modulators, apply the one or more adjustments to the visible wavelength color data channels, the one or more adjustments comprising an adjustment associated with one or more of white balance, tone mapping, demosaicing, color noise reduction, color correction, image sharpening, or image scaling.

11. The processor of claim 1, wherein the one or more processing units are further to:
determine, for a first pixel of the image data, when at least one color channel from the plurality of visible wavelength color data channels is saturated;
determine an output level corresponding to the non-visible wavelength IR data for a second pixel of the image data where a color channel corresponding to the at least one color channel is not saturated; and
correct the at least one color channel for the first pixel based on the output level corresponding to the non-visible wavelength IR data for the second pixel.

12. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more vision language models (VLMs);
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

13. A system comprising:
one or more processing units to:
define a plurality of visible wavelength color data channels based at least on color data from a captured image frame;
define at least one control channel based at least on non-visible wavelength light data from the captured image frame;
propagate the at least one control channel through one or more image color data channel processing stages of an image signal processor (ISP); and
apply one or more adjustments to the visible wavelength color data channels at the one or more image color data channel processing stages, using one or more image modulators determined at least in part from the at least one control channel.

14. The system of claim 13, wherein the one or more processing units are further to:
generate the at least one control channel based at least on a difference between a brightness of the plurality of visible wavelength color data channels and a brightness of the non-visible wavelength light data.

15. The system of claim 13, wherein the one or more processing units are further to:
generate the at least one control channel based at least on a pseudo-radiometric (PR) channel computed as a weighted sum of one or more individual color channels of the plurality of visible wavelength color data channels, and the non-visible wavelength light data from the captured image frame.

16. The system of claim 13, wherein the one or more processing units are further to:
compute the one or more image modulators based at least on channel statistics associated with the at least one control channel and the plurality of visible wavelength color data channels.

17. The system of claim 13, wherein the one or more processing units are further to:
apply the one or more adjustments to the visible wavelength color data channels based on correlating image structural data from the at least one control channel with image structural data from the plurality of visible wavelength color data channels.

18. The system of claim 13, wherein the one or more processing units are further to:
apply, based at least on the one or more image modulators, the one or more adjustments to the visible wavelength color data channels comprising an adjustment associated with one or more of white balance, tone mapping, demosaicing, color noise reduction, color correction, image sharpening, or image scaling.

19. The system of claim 13, wherein the one or more processing units are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more vision language models (VLMs);
a system implementing one or more large language models (LLMs);
a system for generating synthetic data;
a system for generating synthetic data using AI;
a system incorporating one or more virtual machines (VMs);
a system implemented at least partially in a data center; or a system implemented at least partially using cloud computing resources.

20. A method comprising:
applying one or more image modulators to adjust visible wavelength color data channels of image data at one or more image color data channel processing stages of an image signal processor (ISP), the one or more image modulators based on at least one control channel propagated through the one or more image color data channel processing stages, the at least one control channel based at least on non-visible wavelength IR data from the image data.
